(19) United States
(12) Patent Application Publication
(10) Pub. No.: US 2015/0063464 A1
(43) Pub. Date: Mar. 5, 2015

(54) LOOKUP TABLE CODING

(71) Applicant: QUALCOMM Incorporated, San Diego, CA (US)

(72) Inventors: Ying Chen, San Diego, CA (US); Marta Karczewicz, San Diego, CA (US)

(21) Appl. No.: 14/472,040

(22) Filed: Aug. 28, 2014

Related U.S. Application Data
(60) Provisional application No. 61/872,542, filed on Aug. 30, 2013.
(60) Provisional application No. 61/879,934, filed on Sep. 19, 2013.

(51) Int. Cl. H04N 19/85; H04N 19/44; H04N 19/70

(52) U.S. Cl. CPC H04N 19/00903; H04N 19/00884; H04N 19/00533
USPC 375/240.25

(57) ABSTRACT

In general, techniques are described for lookup table coding. A device comprising one or more processors and a memory may be configured to perform the techniques. The processors are configured to receive at least one difference table including a set of values, each value of the set being included or not included in the reference lookup table and generate a current lookup table based on the reference lookup table and the difference table. The current lookup table may include at least one of a value from the difference table that is not included in the reference table or a value from the reference table that is not included in the difference table. The one or more processors may then decode the video data based on a set of values of the current lookup table. The memory may be configured to store the current lookup table.

This application claims the benefit of U.S. Provisional Application No. 61/872,542, filed Aug. 30, 2013, and U.S. Provisional Application No. 61/879,934, filed Sep. 19, 2013, each of which is hereby incorporated by reference in its entirety.

### TECHNICAL FIELD

This disclosure relates to video coding and compression, and more particularly, techniques for coding lookup tables for video coding.

### BACKGROUND

Digital video capabilities can be incorporated into a wide range of devices, including digital televisions, digital direct broadcast systems, wireless broadcast systems, tablet computers, smartphones, personal digital assistants (PDAs), laptop or desktop computers, digital cameras, digital recording devices, digital media players, video gaming devices, video game consoles, cellular or satellite radio telephones, video teleconferencing devices, set-top devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard, and extensions of such standards. The video devices may transmit, receive and store digital video information more efficiently.

An encoder-decoder (codec) applies video compression techniques to perform spatial (intra-picture) prediction and/or temporal (inter-picture) prediction to reduce or remove redundancy inherent in video sequences. For block-based video coding, a video slice may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures alternatively may be referred to as frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the spatial domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

A multi-view coding bitstream may be generated by encoding views, e.g., from multiple perspectives. Multi-view coding may allow a decoder to choose between different views, or possibly render multiple views. Moreover, some three-dimensional (3D) video techniques and standards that have been developed, or are under development, make use of multiview coding aspects. For example, different views may transmit left and right eye views to support 3D video. Some 3D video coding processes may apply so-called multiview-plus-depth coding. In multiview-plus-depth coding, a 3D video bitstream may contain multiple views that include not only texture view components, but also depth view components. For example, each view may comprise a texture view component and a depth view component.

### SUMMARY

The techniques of this disclosure generally relate to techniques for coding a current lookup table based on a reference lookup table. More particularly, the techniques of this disclosure include identifying a set of values that are included in one of the current lookup table and the reference lookup table, but not in both of the current lookup table and the reference lookup table. The techniques of this disclosure further include coding at least one difference table including the identified set of values. In some examples, the lookup tables are depth lookup tables (DLTs) for coding depth maps for a multiview-plus-depth video bitstream. In such examples, the techniques may include coding a DLT for a current view based on a DLT from a reference view.

In one aspect, a method of decoding video data comprises receiving a reference lookup table, and receiving at least one difference table including a set of values, each value of the set being included or not included in the reference lookup table. The method also comprises generating a current lookup table based on the reference lookup table and the difference table, wherein the current lookup table includes at least one of a value from the difference table that is not included in the reference table or a value from the reference table that is not included in the difference table, and decoding the video data based on a set of values of the current lookup table.

In another aspect, a method of encoding video data comprises encoding the video data based on values of a current lookup table to generate encoded video data, and identifying a reference lookup table. The method further comprising signaling at least one difference table to a video decoder, the difference table identifying a set of values that are included in one of the reference lookup table and the current lookup table, but not in both of the reference lookup table and the current lookup table such that the current lookup table is obtained at least in part based on the reference lookup table and the difference table for use in decoding the encoded video data.

In another aspect, a device comprises one or more processors configured to receive at least one difference table including a set of values, each value of the set being included or not included in the reference lookup table, generate a current lookup table based on the reference lookup table and the difference table, wherein the current lookup table includes at least one of a value from the difference table that is not included in the reference table or a value from the reference table that is not included in the difference table, and decode the video data based on a set of values of the current lookup table, and a memory configured to store the current lookup table.

In another aspect, A device comprises a memory configured to store a current lookup table, and one or more processors configured to encode the video data based on values of the current lookup table to generate encoded video data, identify a reference lookup table, and signal at least one difference table to a video decoder, the difference table identifying a set of values that are included in one of the reference lookup table and the current lookup table, but not in both of the reference lookup table and the current lookup table such that the current lookup table is obtained at least in part based on the reference lookup table and the difference table for use in decoding the encoded video data.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video coding system that may utilize the techniques of this disclosure.

FIG. 2 is a diagram illustrating intra prediction modes used in high efficiency video coding (HEVC).

FIG. 3 is a diagram illustrating an example of one wedgelet partition pattern for use in coding an 8×8 block of pixel samples.

FIG. 4 is a diagram illustrating an example of one contour partition pattern for use in coding an 8×8 block of pixel samples.

FIG. 5 is a diagram illustrating eight possible types of chains defined in a region boundary chain coding process.

FIG. 6 is a diagram illustrating a region boundary chain coding mode with one depth prediction unit (PU) partition pattern and the coded chains in chain coding.

FIG. 7 is a block diagram illustrating an example video encoder that may implement the techniques of this disclosure.

FIG. 8 is a block diagram illustrating an example video decoder that may implement the techniques of this disclosure.

FIG. 9 is a flowchart illustrating configured operation of a video encoder in performing the lookup table coding techniques described in this disclosure.

FIG. 10 is a flowchart illustrating configured operation of a video decoder in performing the lookup table coding techniques described in this disclosure.

### DETAILED DESCRIPTION

The techniques of this disclosure generally relate to techniques for coding a current lookup table based on a reference lookup table. More particularly, the techniques of this disclosure include identifying a set of values that are included in one of the current lookup table and the reference lookup table, but not in both of the current lookup table and the reference lookup table. The techniques of this disclosure further include coding at least one difference table including the identified set of values.

In some examples, the lookup tables are depth lookup tables (DLTs) for coding depth maps for a multiview-plus-depth video bitstream. In such examples, the techniques may include coding a DLT for a current view based on a DLT from a reference view. The reference view may be, for example, a base view for the multiview-plus-depth video bitstream.

This disclosure describes techniques for 3D video coding based on advanced codecs, such as High Efficiency Video Coding (HEVC) codecs. The 3D coding techniques described in this disclosure include depth coding techniques related to advanced inter-coding of depth views in a multiview-plus-depth video coding process, such as the 3D-HEVC extension to HEVC, which is presently under development.

In HEVC, assuming that the size of a coding unit (CU) is 2N×2N, a video encoder and video decoder may support various prediction unit (PU) sizes of 2N×2N or N×N for intra-prediction, and symmetric PU sizes of 2N×2N, 2N×N, N×2N, N×N, or similar for inter-prediction. A video encoder and video decoder may also support asymmetric partitioning for PU sizes of 2N×nU, 2N×nD, nL×2N, and nR×2N for inter-prediction.

For depth coding as provided in 3D-HEVC, a video encoder and video decoder may be configured to support a variety of different depth coding partition modes for intra-prediction or inter-prediction, including modes that use non-rectangular partitions. Examples of depth coding with non-rectangular partitions include wedgelet partition-based depth coding and contour partition-based depth coding. Techniques for partition-based inter-coding of non-rectangular partitions, such as wedgelet partitions or contour partitions, as examples, may be performed in conjunction with an a simplified depth coding (SDC) process for depth intra coding of residual information.

Video data coded using 3D video coding techniques may be rendered and displayed to produce a three-dimensional effect. As one example, two images of different views (i.e., corresponding to two camera perspectives having slightly different horizontal positions) may be displayed substantially simultaneously such that one image is seen by a viewer's left eye, and the other image is seen by the viewer's right eye.

A 3D effect may be achieved using, for example, stereoscopic displays or autostereoscopic displays. Stereoscopic displays may be used in conjunction with eyewear that filters the two images accordingly. For example, passive glasses may filter the images using polarized lenses or different colored lenses to ensure that the proper eye views the proper image. Active glasses, as another example, may rapidly shutter alternate lenses in coordination with the stereoscopic display, which may alternate between displaying the left eye image and the right eye image. Autostereoscopic displays display the two images in such a way that no glasses are needed. For example, autostereoscopic displays may include mirrors or prisms that are configured to cause each image to be projected into a viewer's appropriate eyes.

The techniques of this disclosure relate to techniques for coding 3D video data by coding texture and depth data to support 3D video. In general, the term “texture” is used to describe luminance (that is, brightness or “luma”) values of an image and chrominance (that is, color or “chroma”) values of the image. In some examples, a texture image may include one set of luminance data (Y) and two sets of chrominance data for blue hues (Cb) and red hues (Cr). In certain chroma formats, such as 4:2:2 or 4:2:0, the chroma data is downsampled relative to the luma data. That is, the spatial resolution of chrominance pixels may be lower than the spatial resolution of corresponding luminance pixels, e.g., one-half or one-quarter of the luminance resolution.

Depth data generally describes depth values for corresponding texture data. For example, a depth image may include a set of depth pixels (or depth values) that each describes depth, e.g., in a depth component of a view, for corresponding texture data, e.g., in a texture component of the view. Each pixel may have one or more texture values (e.g., luminance and chrominance), and may also have a one or more depth values. The depth data may be used to determine horizontal disparity for the corresponding texture data, and in some cases, vertical disparity may also be used.

A device that receives the texture and depth data may display a first texture image for one view (e.g., a left eye view) and use the depth data to modify the first texture image to generate a second texture image for the other view (e.g., a right eye view) by offsetting pixel values of the first image by the horizontal disparity values determined based on the depth values. In general, horizontal disparity (or simply “disparity”) describes the horizontal spatial offset of a pixel in a first view to a corresponding pixel in the right view, where the two pixels correspond to the same portion of the same object as represented in the two views.

In still other examples, depth data may be defined for pixels in a z-dimension perpendicular to the image plane, such that a depth associated with a given pixel is defined relative to a zero disparity plane defined for the image. Such depth may be used to create horizontal disparity for displaying the pixel, such that the pixel is displayed differently for the left and right eyes, depending on the z-dimension depth value of the pixel relative to the zero disparity plane. The zero disparity plane may change for different portions of a video sequence, and the amount of depth relative to the zero-disparity plane may also change.

Pixels located on the zero disparity plane may be defined similarly for the left and right eyes. Pixels located in front of the zero disparity plane may be displayed in different locations for the left and right eye (e.g., with horizontal disparity) so as to create a perception that the pixel appears to come out of the image in the z-direction perpendicular to the image plane. Pixels located behind the zero disparity plane may be displayed with a slight blur, to slight perception of depth, or may be displayed in different locations for the left and right eye (e.g., with horizontal disparity that is opposite that of pixels located in front of the zero disparity plane). Many other techniques may also be used to convey or define depth data for an image.

Two-dimensional video data is generally coded as a sequence of discrete pictures, each of which corresponds to a particular temporal instance. That is, each picture has an associated playback time relative to playback times of other images in the sequence. These pictures may be considered texture pictures or texture images. In depth-based 3D video coding, each texture picture in a sequence may also correspond to a depth map. That is, a depth map corresponding to a texture picture describes depth data for the corresponding texture picture. Multiview video data may include data for various different views, where each view may include a respective sequence of texture components and corresponding depth components.

A picture generally corresponds to a particular temporal instance. Video data may be represented using a sequence of access units, where each access unit includes all data corresponding to a particular temporal instance. Thus, for example, for multiview video data plus depth coding, texture images from each view for a common temporal instance, plus the depth maps for each of the texture images, may all be included within a particular access unit. Hence, an access unit may include multiple views, where each view may include data for a texture component, corresponding to a texture image, and data for a depth component, corresponding to a depth map.

Each access unit may contain multiple view components. Each view component may be associated with a unique view id, view order index, or layer id. A view component may include a texture view component as well as a depth view component. A texture view component may be coded as one or more texture slices, while the depth view component may be coded as one or more depth slices. Multiview-plus-depth creates a variety of coding possibilities, such as intra-picture, inter-picture, intra-view, inter-view, motion prediction, and the like.

In this manner, 3D video data may be represented using a multiview video plus depth format, in which captured or generated views (texture) are associated with corresponding depth maps. Moreover, in 3D video coding, textures and depth maps may be coded and multiplexed into a 3D video bitstream. Depth maps may be coded as grayscale images, where “luma” samples (that is, pixels) of the depth maps represent depth values.

In general, a block of depth data (a block of samples of a depth map) may be referred to as a depth block. A depth value may be referred to as a luma value associated with a depth sample. In any case, conventional intra- and inter-coding methods may be applied for depth map coding.

Depth maps commonly are characterized by sharp edges and constant areas, and edges in depth maps typically present strong correlations with corresponding texture data. Due to the different statistics and correlations between texture and corresponding depth, different coding schemes have been designed for depth maps based on a 2D video codec.

HEVC techniques related to this disclosure are reviewed below. Examples of video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. The latest joint draft of MVC is described in “Advanced video coding for generic audiovisual services,” ITU-T Recommendation H.264, March 2010.

In addition, High Efficiency Video Coding (HEVC), mentioned above, is a new and upcoming video coding standard, developed by the Joint Collaboration Team on Video Coding (JCT-VC) of ITU-T Video Coding Experts Group (VCEG) and ISO/IEC Motion Picture Experts Group (MPEG). A recent draft of the HEVC standard, JCTVC-L1003, Benjamin Bross Woo-Jin Han, Jens-Ranier Ohm, Gary Sullivan, Ye-Kui Wang, Thomas Wiegand, “High Efficiency Video Coding (HEVC) text specification draft 10 (for FDIS & Consent),” Joint Collaborative Team on Video Coding (JCT-VC) of ITU-T SG 16 WP 3 and ISO/IEC JTC 1/SC 29/WG 11, 12th Meeting: Geneva, CH, 14-23 Jan. 2013, and is available from the following link: http://phenix.int-evry.fr/jct/doc_end_user/documents/12_Geneva/wg11/JCTVC-L1003-v34.zip.

In JCT-3V, two HEVC extensions, the mutiview extension (MV-HEVC) and 3D video extension (3D-HEVC) are being developed. A recent version of the reference software, “3D-HTM version 8.0,” for 3D-HEVC can be downloaded from the following link: https://hevc.hhi.fraunhofer.de/svn/svn_{—}3DVCSoftware/tags/HTM-8.0/.

A recent draft of the software description for 3D-HEVC, Gerhard Tech, Krzystof Wegner, Ying Chen, Sehoon Yea, “3D-HEVC Test Model 2,” Document: JCT3V-B1005_d0, Joint Collaborative Team on 3D Video Coding Extension Development of ITU-T SG 16 WP 3 and ISO/IEC JTC 1/SC 29/WG 11, 2^{nd} Meeting: Shanghai, CN, 13-19 Oct. 2012, and is available from the following link: http://phenix.it-sudparis.eu/jct2/doc_end_user/documents/5_Vienna/wg11/JCT3V-E1001-v3.zip.

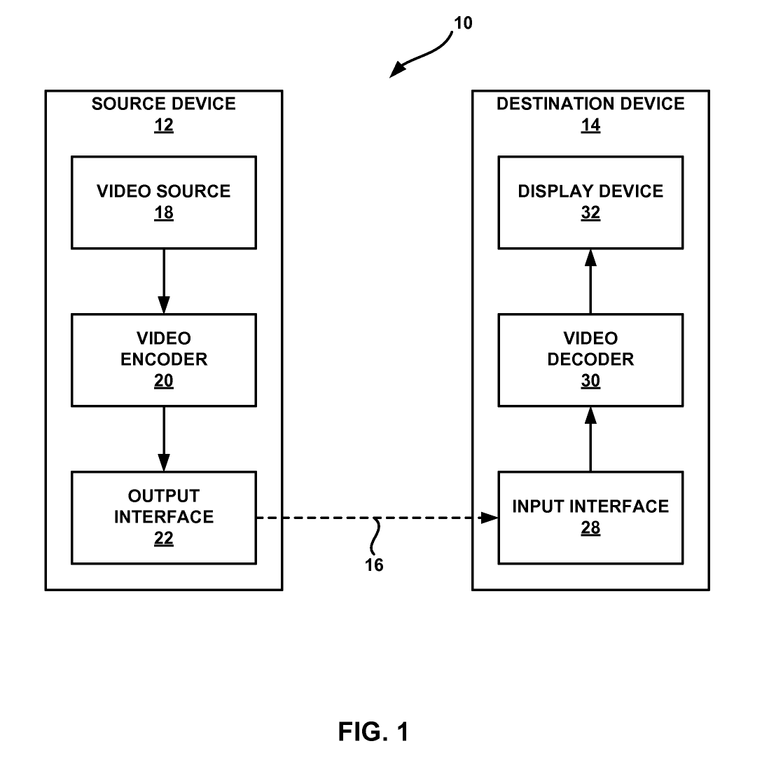

FIG. 1 is a block diagram illustrating an example video encoding and decoding system 10 that may utilize various techniques of this disclosure for depth coding. In some examples, video encoder 20 and video decoder 30 may be configured to perform various functions for partition-based inter-coding of depth data with simplified depth coding of residual information for 3D video coding. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time.

The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a computer-readable storage medium, i.e., a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12.

Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply techniques for partition-based depth coding with non-rectangular partitions. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for lookup table coding may be performed by any digital video encoding and/or decoding device. Although generally the techniques of this disclosure are performed by a video encoder 20 and/or video decoder 30, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer generated video. In some cases, if video source 18 is a video camera, source device 12 and destination device 14 may form so-called smart phones, tablet computers or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or data storage media (that is, non-transitory storage media). In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

This disclosure may generally refer to video encoder 20 “signaling” certain information to another device, such as video decoder 30. It should be understood, however, that video encoder 20 may signal information by associating certain syntax elements with various encoded portions of video data. That is, video encoder 20 may “signal” data by storing certain syntax elements to headers or in payloads of various encoded portions of video data. In some cases, such syntax elements may be encoded and stored (e.g., stored to computer-readable medium 16) prior to being received and decoded by video decoder 30. Thus, the term “signaling” may generally refer to the communication of syntax or other data for decoding compressed video data, whether such communication occurs in real- or near-real-time or over a span of time, such as might occur when storing syntax elements to a medium at the time of encoding, which then may be retrieved by a decoding device at any time after being stored to this medium.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, a projection device, or another type of display device.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, as one example, or other protocols such as the user datagram protocol (UDP).

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). A device including video encoder 20 and/or video decoder 30 may comprise an integrated circuit, a microprocessor, and/or a wireless communication device, such as a cellular telephone.

Video encoder 20 and video decoder 30 may operate according to a video coding standard, such as the HEVC standard and, more particularly, the 3D-HEVC extension of the HEVC standard, as referenced in this disclosure. HEVC presumes several additional capabilities of video coding devices relative to devices configured to perform coding according to other processes, such as, e.g., ITU-T H.264/AVC. For example, whereas H.264 provides nine intra-prediction encoding modes, the HM may provide as many as thirty-five intra-prediction encoding modes.

In general, HEVC specifies that a video picture (or “frame”) may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. Four sub-CUs of a leaf-CU may also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU in HEVC has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape, or include partitions that are non-rectangular in shape, in the case of depth coding as described in this disclosure. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving reference samples for the PU. The reference samples may be pixels from a reference block. In some examples, the reference samples may be obtained from a reference block, or generated, e.g., by interpolation or other techniques. A PU also includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder 20 may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to a leaf-CU and leaf-TU, respectively, unless noted otherwise.

A video sequence typically includes a series of pictures. As described herein, “picture” and “frame” may be used interchangeably. That is, a picture containing video data may be referred to as a video frame, or simply a “frame.” A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, HEVC supports prediction in various PU sizes. Assuming that the size of a particular CU is 2N×2N, HEVC supports intra-prediction in PU sizes of 2N×2N or N×N, and inter-prediction in symmetric PU sizes of 2N×2N, 2N×N, N×2N, or N×N. A PU having a size of 2N×2N represents an undivided CU, as it is the same size as the CU in which it resides. In other words, a 2N×2N PU is the same size as its CU. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, video encoder 20 may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array.

In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

Video encoder 20 may further send syntax data, such as block-based syntax data, picture-based syntax data, and GOP-based syntax data, to video decoder 30, e.g., in a picture header, a block header, a slice header, or a GOP header. The GOP syntax data may describe a number of pictures in the respective GOP, and the picture syntax data may indicate an encoding/prediction mode used to encode the corresponding picture.

Video encoder 20 and/or video decoder 30 may intra-code depth data. In addition, in accordance with examples of this disclosure, video encoder 20 and/or video decoder 30 may inter-code depth data. In particular, video encoder 20 and/or video decoder 30 may perform partition-based inter-coding of depth data, using non-rectangular partitions, and may perform a simplified depth coding (SDC) of residual data for depth intra coding, as will be described.

For example, in 3D-HEVC, video encoder 20 and/or video decoder 30 may use Depth Modeling Modes (DMMs) to code a prediction unit of a depth slice. In some instances, four DMMs may be available for intra-coding depth data. In all four modes, video encoder 20 and/or video decoder 30 partitions a depth block into more than one region, as specified by a DMM pattern. Video encoder 20 and/or video decoder 30 then generates a predicted depth value for each region, which may be referred to as a “DC” predicted depth value that is based on the values of neighboring depth samples.

The DMM pattern may be explicitly signaled, predicted from spatially neighboring depth blocks, and/or predicted from a co-located texture block. For example, a first DMM (e.g., DMM mode 1) may include signaling starting and/or ending points of a partition boundary of a depth block. A second DMM (e.g., DMM mode 2) may include predicting partition boundaries of a depth block based on a spatially neighboring depth block. Third and fourth DMMs (e.g., DMM mode 3 and DMM mode 4) may include predicting partition boundaries of a depth block based on a co-located texture block of the depth block.

With four DMMs available, there may be signaling associated with each of the four DMMs (e.g., DMM modes 1-4). For example, video encoder 20 may select a DMM to code a depth PU based on a rate-distortion optimization. Video encoder 20 may provide an indication of the selected DMM in an encoded bitstream with the encoded depth data. Video decoder 30 may parse the indication from the bitstream to determine the appropriate DMM for decoding the depth data. In some instances, a fixed length code may be used to indicate a selected DMM. In addition, the fixed length code may also indicate whether a prediction offset (associated with a predicted DC value) is applied.

As noted above, a video encoder 20 and/or video decoder 30 configured in accordance with one or more aspects of this disclosure may further include features for applying partition-based coding, e.g., using partitions defined by DMMs, for inter-coding, and may apply a SDC (which again may refer to simplified depth coding) of residual data for depth intra coding. In some examples of SDC, rather than coding the residual value, video encoder 20 and/or video decoder 30 a configured to code, e.g., encode or decode, an index difference mapped from a depth lookup table (DLT). Video decoder 30 derives the coded depth value from the DLT. Video encoder 20 signals DLTs to video decoder 30 in a syntax structure, such as a parameter set (e.g., a sequence parameter set, a picture parameter set, or a video parameter set).

The techniques of this disclosure may simplify, e.g., reduce the amount of data included with a video bitstream for, signaling lookup tables, such as DLTs. In particular, the techniques of this disclosure relate to prediction of a current lookup table, e.g., a DLT for a current view, from a reference lookup table, e.g., a reference DLT. More particularly, the techniques of this disclosure include identifying a set of values that are included in one of the current lookup table and the reference lookup table, but not in both of the current lookup table and the reference lookup table. The techniques of this disclosure further include coding at least one difference table including the identified set of values.

In this manner, the entirety of the current lookup table need not be signaled. Rather, the one or more difference tables, including fewer values than the current lookup table, may be signaled. Video decoder 30 may determine the current lookup table, e.g., current DLT, based on the signaled difference table(s) and the reference lookup table.

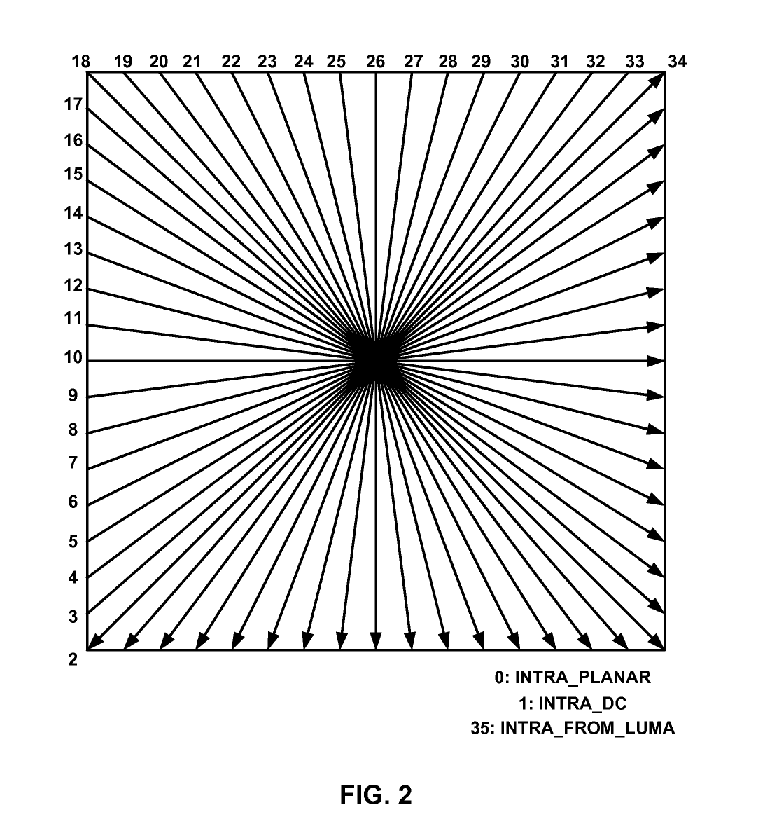

FIG. 2 is a diagram illustrating intra prediction modes used in high efficiency video coding (HEVC). FIG. 2 generally illustrates the prediction directions associated with various directional intra-prediction modes available for intra-coding in HEVC. In the current HEVC standard, for the luma component of each Prediction Unit (PU), an intra prediction method is utilized with 33 angular prediction modes (indexed from 2 to 34), DC mode (indexed with 1) and Planar mode (indexed with 0), as shown in FIG. 2.

With planar mode, prediction is performed using a so-called “plane” function. With DC mode, prediction is performed based on an averaging of pixel values within the block. With a directional prediction mode, prediction is performed based on a neighboring block's reconstructed pixels along a particular direction (as indicated by the mode). In general, the tail end of the arrows shown in FIG. 1 represents a relative one of neighboring pixels from which a value is retrieved, while the head of the arrows represents the direction in which the retrieved value is propagated to form a predictive block.

3D-HEVC in MPEG will now be described in further detail. A Joint Collaboration Team on 3D Video Coding (JCT-3V) of VCEG and MPEG is developing a 3D video (3DV) standard based on HEVC, for which part of the standardization efforts includes the standardization of the multiview video codec based on HEVC (MV-HEVC) and another part for 3D Video coding based on HEVC (3D-HEVC), mentioned above. For 3D-HEVC, new coding tools, including those in coding unit (CU)/prediction unit (PU) level, for both texture and depth views may be included and supported.

Currently, the HEVC-based 3D Video Coding (3D-HEVC) codec in MPEG is based on the solutions proposed in documents m22570 and m22571. The full citation for m22570 is: Schwarz et al., Description of 3D Video Coding Technology Proposal by Fraunhofer HHI (HEVC compatible configuration A), MPEG Meeting ISO/IEC JTC1/SC29/WG11, Doc. MPEG11/M22570, Geneva, Switzerland, November/December 2011. The full citation for m22571 is: Schwarz et al., Description of 3D Video Technology Proposal by Fraunhofer HHI (HEVC compatible; configuration B), MPEG Meeting—ISO/IEC JTC1/SC29/WG11, Doc. MPEG11/M22571, Geneva, Switzerland, November/December 2011. The latest reference software HTM version 7.0 for the 3D-HEVC standard presently under development can be downloaded from the following link: [HTM-7.0]: https://hevc.hhi.fraunhofer.de/svn/svn_{—}3DVCSoftware/tags/HTM-7.0/The latest software description (document number: D1005) as well as the working draft of the 3D-HEVC standard is available from the following link: http://phenix.it-sudparis.eu/jct2/doc_end_user/documents/4_Incheon/wg11/JCT3V-D1005-v1.zip The link immediately above includes the following documents: D1005_spec_v1 and JCT3V-D1005_v1. These documents are identified as follows: Gerhard Tech, Krzysztof Wegner, Ying Chen, Sehoon Yea, “3D-HEVC Test Model 4,” JCT3V-D1005_spec_v1, Joint Collaborative Team on 3D Video Coding Extension Development of ITU-T SG 16 WP 3 and ISO/IEC JTC 1/SC 29/WG 11, 4th Meeting: Incheon, KR, 20-26, April 2013, and Gerhard Tech, Krzysztof Wegner, Ying Chen, Sehoon Yea, “3D-HEVC Test Model 4,” JCT3V-D1005_v1, Joint Collaborative Team on 3D Video Coding Extension Development of ITU-T SG 16 WP 3 and ISO/IEC JTC 1/SC 29/WG 11, 4th Meeting: Incheon, KR, 20-26, April 2013, (collectively hereinafter “D1005” or “WD3”).

In 3D-HEVC, each access unit contains multiple view components, each of which contains a unique view id, or view order index, or layer id. A view component contains a texture view component as well as a depth view component, as described above. A texture view component is coded as one or more texture slices, while the depth view component is coded as one or more depth slices.

When 3D video data is represented using the multiview video plus depth format, texture view components are associated with corresponding depth video components, which are coded and multiplexed in a 3D video bitstream by video encoder 20. Video encoder 20 and/or video decoder 30 code the depth maps in the depth view components as grayscale luma samples to represent the depth values, and may use conventional intra- and inter-coding methods for depth map coding.

Depth maps are characterized by sharp edges and constant areas. Accordingly, due to the different statistics of depth map samples, different coding schemes have been designed for coding of depth maps by video encoder 20 and/or video decoder 30, based on a 2D video codec.

In 3D-HEVC, the same definition of intra prediction modes as in HEVC is utilized. In 3D-HEVC, Depth Modeling Modes (DMMs) are introduced together with the HEVC intra prediction modes, e.g., as described above with reference to FIG. 2, to code an Intra prediction unit of a depth slice.

For better representations of sharp edges in depth maps, the current reference software HTM applies a DMM method for intra coding of a depth map. There are four intra modes in DMM for 3D-HEVC. In all four modes, a depth block is partitioned into two regions specified by a DMM pattern, where each region is represented by a constant value. The DMM pattern can be either explicitly signaled (DMM mode 1), predicted by spatially neighboring blocks (DMM mode 2), or predicted by a co-located texture block (DMM mode 3 and DMM mode 4).

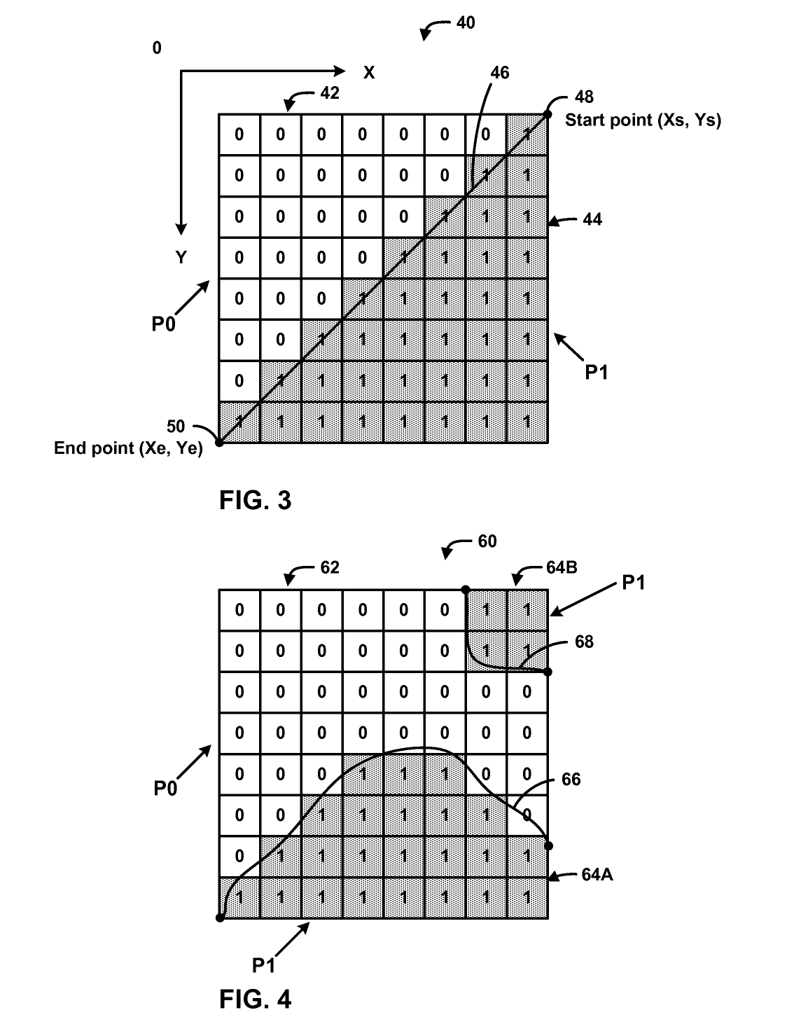

There are two types of partitioning models defined in the DMM, including Wedgelet partitioning and Contour partitioning. FIG. 3 is a diagram illustrating an example of a Wedgelet partition pattern for use in coding an 8×8 block of pixel samples. FIG. 4 is a diagram illustrating an example of a contour partition pattern for use in coding an 8×8 block of pixel samples.

Hence, as one example, FIG. 3 provides an illustration of a Wedgelet pattern for an 8×8 block. For a Wedgelet partition, a depth block is partitioned into two regions by a straight line, with a start point located at (Xs, Ys) and an end point located at (Xe, Ye), as illustrated in FIG. 3, where the two regions are labeled with P₀ and P₁. Each pattern consists of an array of size uB×vB binary digit labeling whether the corresponding sample belongs to region P0 or P1 where uB and vB represents the horizontal and vertical size of the current PU respectively. The regions P0 and P1 are represented in FIG. 3 by white and shaded samples, respectively. The Wedgelet patterns are initialized at the beginning of both encoding and decoding.

FIG. 4 shows a contour pattern for an 8×8 block. For a Contour partitioning, video encoder 20 may partition a depth block into two irregular regions, as shown in FIG. 4. The contour partitioning is more flexible than the Wedgelet partitioning, but may be difficult to signal explicitly. In DMM mode 4, a contour partitioning pattern is implicitly derived using reconstructed luma samples of the co-located texture block.

The DMM method is integrated as an alternative to the intra prediction modes specified in HEVC. A one-bit flag is signaled for each PU to specify whether DMM or unified intra prediction is applied.

With reference to FIGS. 3 and 4, each individual square within depth blocks 40 and 60 represents a respective individual pixel of depth blocks 40 and 60, respectively. Numeric values within the squares represent whether the corresponding pixel belongs to region 42 (value “0” in the example of FIG. 3) or region 44 (value “1” in the example of FIG. 3). Shading is also used in FIG. 3 to indicate whether a pixel belongs to region 42 (white squares) or region 44 (grey shaded squares).

As discussed above, each pattern (that is, both Wedgelet and Contour) may be defined by an array of size uB×vB binary digit labeling of whether the corresponding sample (that is, pixel) belongs to region P0 or P1 (where P0 corresponds to region 42 in FIG. 3 and region 62 in FIG. 4, and P1 corresponds to region 44 in FIG. 3 and regions 64A and 64B in FIG. 4), where uB and vB represent the horizontal and vertical size of the current PU, respectively. In the examples of FIG. 3 and FIG. 4, the PU corresponds to blocks 40 and 60, respectively. Video coders, such as video encoder 20 and video decoder 30, may initialize Wedgelet patterns at the beginning of coding, e.g., the beginning of encoding or the beginning of decoding.

As shown in the example of FIG. 3, for a Wedgelet partition, depth block 40 is partitioned into two regions, region 42 and region 44, by straight line 46, with start point 48 located at (Xs, Ys) and end point 50 located at (Xe, Ye). In the example of FIG. 3, start point 48 may be defined as point (8, 0) and end point 50 may be defined as point (0, 8).

As shown in the example of FIG. 4, for Contour partitioning, a depth block, such as depth block 60, can be partitioned into two irregularly-shaped regions. In the example of FIG. 4, depth block 60 is partitioned into region 62 and region 64A, 64B using contour partitioning. Although pixels in region 64A are not immediately adjacent to pixels in region 64B, regions 64A and 64B may be defined to form one single region, for the purposes of predicting a PU of depth block 60. Contour partitioning may be more flexible than the Wedgelet partitioning, but may be relatively more difficult to signal. In DMM mode 4, in the case of 3D-HEVC, the contour partitioning pattern is implicitly derived using reconstructed luma samples of the co-located texture block.

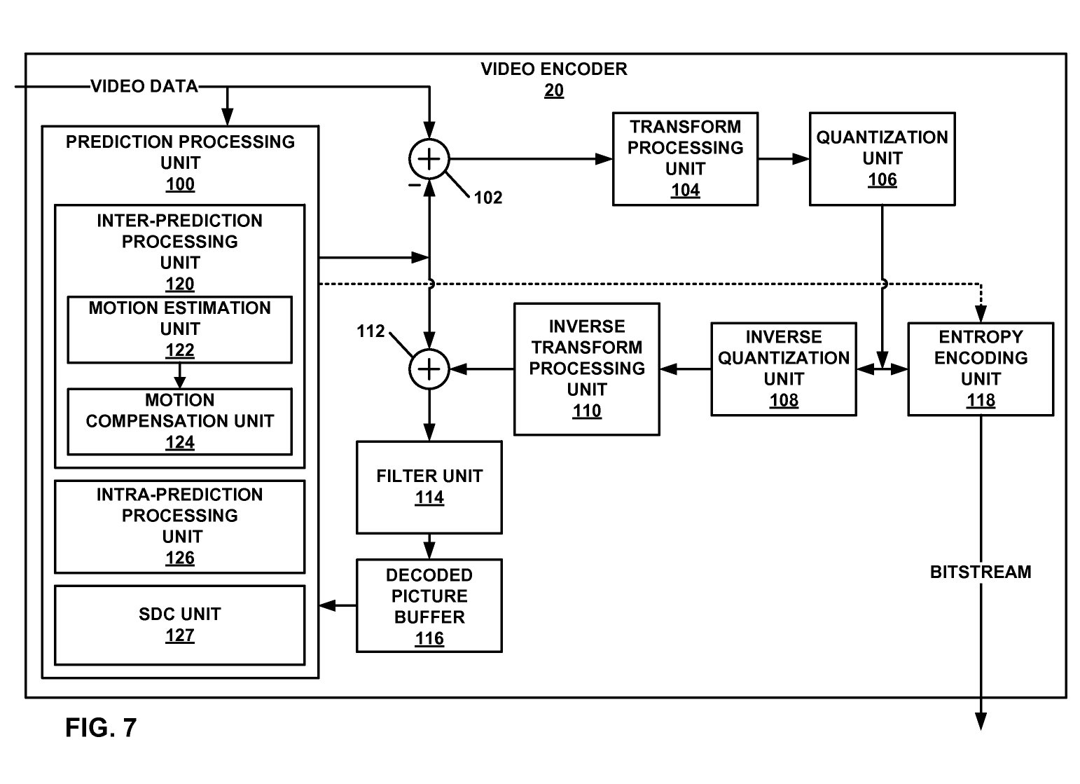

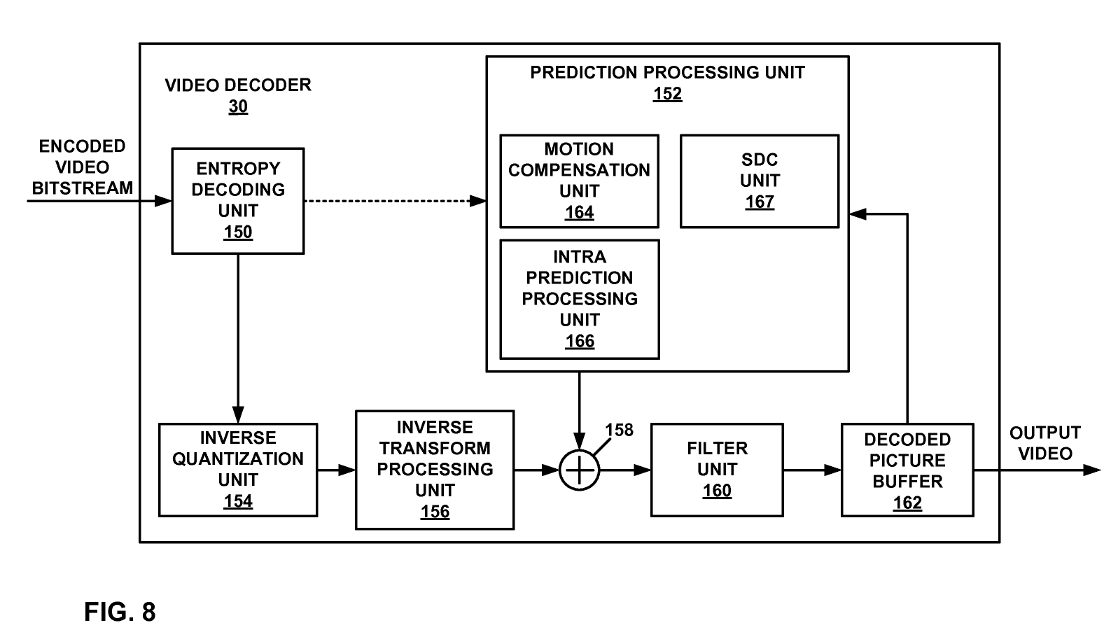

In this manner, a video coder, such as video encoder 20 and video decoder 30 of FIG. 1, and FIGS. 7 and 8 described below, may use line 46, as defined by start point 48 and end point 50, to determine whether a pixel of depth block 40 belongs to region 42 (which may also be referred to as region “P0”) or to region 44 (which may also be referred to as region “P1”), as shown in FIG. 3. Likewise, in some examples, a video coder may use lines 66, 68 of FIG. 4 to determine whether a pixel of depth block 60 belongs to region 64A (which may also be referred to as region “P0”) or to region 64B (which may also be referred to as region “P1”). Regions “P0” and “P1” are default naming conventions for different regions partitioned according to DMM, and thus, region P0 of depth block 40 would not be considered the same region as region P0 of depth block 60.

Region boundary chain coding is another mode in 3D-HEVC. Region boundary chain coding mode is introduced together with the HEVC intra prediction modes and DMM modes to code an intra prediction unit of a depth slice. For brevity, “region boundary chain coding mode” is denoted by “chain coding” for simplicity in the texts, tables and figures described below.

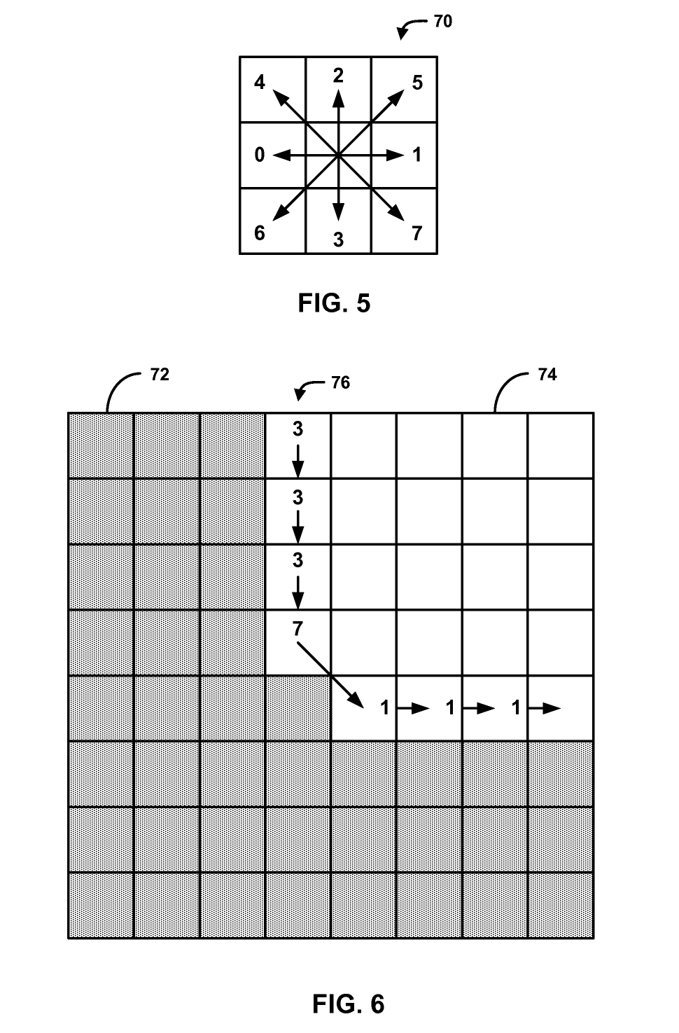

A chain coding of a PU is signaled with a starting position of the chain, the number of the chain codes and for each chain code, a direction index. A chain is a connection between a sample and one of its eight-connectivity samples. FIG. 5 illustrates eight possible types of chains defined in a chain coding process. FIG. 6 illustrates region boundary chain coding mode with one depth prediction unit (PU) partition pattern and the coded chains in chain coding. One example of the chain coding process is illustrated in FIGS. 5 and 6. As shown in FIG. 5, there are eight different types of chain, each assigned with a direction index ranging from 0 to 7. A chain is a connection between a sample and one of its eight-connectivity samples.

To signal the arbitrary partition pattern shown in FIG. 6, a video encoder identifies the partition pattern and encodes the following information in the bitstream:

1. One bit “0” is encoded to signal that the chains start from the top boundary

2. Three bits “011” are encoded to signal the starting position “3” at the top boundary

3. Four bits “0110” are encoded to signal the total number of chains as 7

4. A series of connected chains indexes “3, 3, 3, 7, 1, 1, 1” are encoded, where each chain index is converted to a code word using a look-up-table.

As shown in block 70 of FIG. 5, there are 8 different types of chain, each assigned with a direction index ranging from 0 to 7. The chain direction types may aid a video coder in determining partitions of a depth block. Note, that instead of directly coding the direction index (0 . . . 7), differential coding may be applied for signaling the direction index.

The example of FIG. 6 includes a first partition 72 and a second partition 74 separated by a chain 76 that indicates the partitioning structure. A video encoder (such as video encoder 20) may determine and signal chain 76 for a PU in an encoded bitstream, while a video decoder (such as video decoder 30) may parse data representing chain 76 from an encoded bitstream.

In general, chain 76 includes a starting position, an indication of a number of links in the chain (e.g., a number of chain codes), and for each chain code, a direction index. To signal the arbitrary partition pattern shown in the example of FIG. 6, video encoder 20 may encode one bit (e.g., 0) to indicate that chain 76 begins from the top boundary. Video encoder 20 may encode three bits (e.g., 011) to indicate that chain 76 begins after the third depth sample of the top boundary. Video encoder 20 may encode four bits (e.g., 0110) to indicate that there are 7 total links in chain 76. Video encoder 20 may also encode a series of connected chains indexes (e.g., 3, 3, 3, 7, 1, 1, 1) to indicate the direction of each chain link (e.g., in accordance with block 70). In some examples, video encoder 20 may convert each index to a code word using a look-up-table. A video decoder, such as video decoder 30, may parse the signaling described above to determine the partitioning pattern of a block. Video decoder 30 may then decode depth values for each partition.

In 3D-HEVC, simplified depth coding (SDC) mode is introduced together with the HEVC intra prediction modes, DMM modes and chain coding mode to code an intra PU of a depth slice. For 3D-HEVC, video encoder 20 signals an additional flag for each intra depth PU to specify whether the current PU is coded using SDC modes. In the current 3D-HEVC, SDC is only applied for a 2N×2N PU partition size, and is not applied for PU partition sizes of less than 2N×2N.

When SDC is used, video encoder 20 does not include individual residual values for all samples in a depth block, and does not generate quantized transform coefficients. Instead of coding quantized transform coefficients, in SDC modes, video encoder 20 represents a depth block with the following types of information:

1. The type of partition of the current depth block, including
a. DMM mode 1 (2 partitions)
b. Planar (1 partition)

2. For each partition, a residual value is signaled in the bitstream

Hence, in SDC, video encoder 20 may only encode one residual for each PU of an intra-coded depth CU. For each PU, instead of coding the differences for each pixel, video encoder 20 determines a difference between an average value of the original signal (i.e., an average value of the pixels in the block to be coded) and an average value of the prediction signal (i.e., an average value of the pixel samples in the predictive block), and uses this difference as the residual for all pixels in the PU. Video encoder 20 may then signal or encode this residual value for receipt or decoding by video decoder 30.

For 3D-HEVC, two sub-modes are defined in SDC including SDC mode 1 and SDC mode 2, which correspond to the partition types of Planar and DMM mode 1, respectively. In SDC, as mentioned above, no transform or quantization is applied by video encoder 20. Likewise, in SDC, video decoder 30 does not apply inverse quantization or inverse transform operations.

The depth values can be optionally mapped to indexes using a Depth Lookup Table (DLT), which is constructed by analyzing the frames within a first intra period before encoding a full video sequence. In existing proposals for 3D-HEVC, all of the valid depth values are sorted in ascending order and inserted into the DLT with increasing indexes. According to existing proposals for 3D-HEVC, when a DLT is used, the entire DLT is transmitted by video encoder 20 to video decoder 30 in a sequence parameter set (SPS), and decoded index difference values are mapped back to depth values by video decoder 30 based on the DLT. With the use of DLT, further coding gain may be achieved.

For the signaling of residual in SDC modes, as described above, for each partition, the difference of the representative value of current partition (e.g., Aver for average value) and its predictor (Pred, referring to residual in this example), is signaled by video encoder 20 in the encoded bitstream without transform and quantization. It should be noted that video encoder 20 may signal the residual using two different methods depending on the usage of DLT:

1. When DLT is not used, the delta between the representative value of a current partition (Aver) in current PU form and its predictor (Pred) is directly transmitted or coded.

2. When DLT is used, instead of directly signaling or coding the residual value, i.e., the difference of depth values, video encoder 20 signals or codes the difference of the indices to the DLT, which may refer to the difference between the index of the representative value (Aver) of the current partition and the index of the predictor (Pred) in the DLT. Video decoder 30 maps the sum of decoded index difference and the index of Pred back to depth values based on the DLT.

When the value of the representative value (Aver) of the current partition or the value of the predictor (Pred) is not included in the DLT, a video coder maps the value to an index I, wherein the absolute value of (Pred/Aver—the value of the i-th entry in the DLT) is the minimum one.

According to 3D-HTM version 5.1, video encoder 20 will not use DLT if more than half the values from 0 to MAX_DEPTH_VALUE (e.g., 255 for 8-bit depth samples) appear in the original depth map during the analysis step. Otherwise, video coders will code DLTs in the SPS, or in a video parameter set (VPS). According to 3D-HTM version 5.1, in order to code a DLT, the number of valid depth values is coded with Exp-Golomb code first. Then each valid depth value is also coded with an Exp-Golomb code. The related syntax elements and semantics for signaling a DLT are defined as follows:

### Syntax

G.7.3.2.1.1 Video parameter set extension syntax

| vps_extension( ) { | Descriptor |
|---|---|
| ... | |
| for( i = 0; i <= vps_max_layers_minus1; i++ ) { | |
| if ( (i ! = 0) && !( i % 2 ) ) { | |
| multi_view_mv_pred_flag[ i ] | u(1) |
| multi_view_residual_pred_flag[ i ] | u(1) |
| } | |
| if(i % 2) { | |
| enable_dmm_flag[ i ] | u(1) |
| use_mvi_flag[ i ] | u(1) |
| lim_qt_pred_flag[ i ] | u(1) |
| dlt_flag[ i ] | u(1) |
| if( dlt_flag[ i ] ) { | |
| num_depth_values_in_dlt[ i ] | ue(v) |
| for ( j = 0; j < num_depth_values_in_dlt[ i ]; | |
| j++) { | |
| dlt_depth_value[ i ][ j ] | ue(v) |
| } | |
| } | |
| } | |
| } | |
| } | |

### Semantics

dlt_flag[i] equal to 1 specifies that depth lookup table is used and that residual values for simplified depth coded coding units are specified as indices of the depth lookup table for depth view components with layer_id equal to i. dlt_flag[i] equal to 0 specifies that depth lookup table is not used and residual values for simplified depth coded coding units are not to be interpreted as indices for depth view components with layer_id equal to i. When dlt_flat[i] is not present, it shall be inferred to be equal to 0.
num_depth_values_in_dlt[i] specifies the number of different depth values and the number of elements in the depth lookup table for depth view components of the current layer with layer_id equal to i.
dlt_depth_value[i][j] specifies the j-th entry in the depth lookup table for depth view components with layer_id equal to i.

Note, in 3D-HTM version 5.1, video encoder 20 signals DLTs in the SPS, rather than the VPS as defined in the syntax above.

Below are examples of depth values for dlt_depth_value[i][j] for two typical test sequences:

1) Sequence name: balloons
dlt_depth_value[0][38]=
{58, 64, 69, 74, 80, 85, 90, 96, 101, 106, 112, 117, 122, 128, 133, 138, 143, 149, 154, 159, 165, 170, 175, 181, 186, 191, 197, 202, 207, 213, 218, 223, 228, 234, 239, 244, 250, 255};
dlt_depth_value[1][48]=
{1, 4, 5, 11, 21, 27, 32, 37, 43, 48, 53, 58, 64, 69, 74, 80, 85, 90, 96, 101, 106, 112, 117, 122, 128, 133, 138, 143, 149, 154, 159, 165, 170, 175, 181, 186, 191, 197, 202, 207, 213, 218, 223, 228, 234, 239, 244, 250, 255};
dlt_depth_value[2][44]=
{2, 25, 27, 37, 43, 48, 53, 58, 64, 69, 74, 80, 85, 90, 96, 101, 106, 112, 117, 122, 128, 133, 138, 143, 149, 154, 159, 165, 170, 175, 181, 186, 191, 197, 202, 207, 213, 218, 223, 228, 234, 239, 244, 250, 255};
   2) Sequence name: PoznanHall2
dlt_depth_value[0][39]=
{0, 3, 5, 8, 10, 13, 15, 18, 20, 23, 25, 28, 30, 33, 35, 38, 40, 43, 45, 48, 50, 53, 55, 58, 60, 63, 65, 68, 70, 73, 75, 78, 80, 83, 85, 88, 90, 93, 95};
dlt_depth_value[1][35]=
{3, 5, 8, 10, 13, 15, 18, 20, 23, 25, 28, 30, 33, 35, 38, 40, 43, 45, 48, 50, 53, 55, 58, 60, 63, 65, 68, 70, 73, 75, 78, 80, 83, 85, 88};
dlt_depth_value[2][36]=
{0, 3, 5, 8, 10, 13, 15, 18, 20, 23, 25, 28, 30, 33, 35, 38, 40, 43, 45, 48, 50, 53, 55, 58, 60, 63, 65, 68, 70, 73, 75, 78, 80, 83, 85, 88};

From the bolded/italicized portions of the above examples, most of the valid depth values are the same among different views. For example, the depth values 58, 64, 69, 74, 80, 85, 90, 96, 101, 106, 112, 117, 122, 128, 133, 138, 143, 149, 154, 159, 165, 170, 175, 181, 186, 191, 197, 202, 207, 213, 218, 223, 228, 234, 239, 244, 250, 255 are valid depth values for each of three views of the “balloons” sequence. Similarly, the depth values 3, 5, 8, 10, 13, 15, 18, 20, 23, 25, 28, 30, 33, 35, 38, 40, 43, 45, 48, 50, 53, 55, 58, 60, 63, 65, 68, 70, 73, 75, 78, 80, 83, 85, 88 are valid depth values for each of three views of the “PoznanHall2” sequence. Additionally, the depth value 0 is a valid depth value for two views of the “PoznanHall2” sequence.

The following provides document (denoted “JCT3V-E0130”) for signaling of DLT for depth coding: Zhao et al., “AHG7: On signaling of DLT for depth coding,” Document: JCT3V-E0130, Joint Collaborative Team on 3D Video Coding Extension Development of ITU-T SG 16 WP 3 and ISO/IEC JTC 1/SC 29/WG 11, 5^{th} Meeting: Vienna, AT, 27 Jul.-2 Aug. 2013, (hereinafter “JCT3V-E0130”) is available from the following link: http.//phenix.it-sudparis.eu/jct2/doc_end_user/current_document.php?id=1144. In JCT3V-E0130, single-view DLT has been proposed in a way that the values (increasing) in the table are present and signaled in a differential coding manner, wherein the difference is coded by considering the maximum difference value as an up bound. When inter-view prediction of DLT is considered, JCT3V-E0130 enables the prediction of two DLT tables of two views if they have an overlapped region, and the items in the overlapped region are not signaled.

The following document (denoted “JCT3V-E0176”) provides for what is referred to as an efficiency coding method for DLTs: Zhang et al., “An efficient coding method for DLT in 3D-HEVC,” Document: JCT3V-E0176, Joint Collaborative Team on 3D Video Coding Extension Development of ITU-T SG 16 WP 3 and ISO/IEC JTC 1/SC 29/WG 11, 5^{th} Meeting: Vienna, AT, 27 Jul.-2 Aug. 2013, (hereinafter “JCT3V-E0176”) is available from the following link: http://phenix.it-sudparis.eu/jct2/doc_end_user/current_document.php?id=1190. In JCT3V-E0176, single-view DLT has been proposed in what may be characterized as a much more complicated fashion, where a bit map needs to be created for each depth value. However, in this proposal, the minimum difference value is used to calculate the difference.

A differential coding method for DLT is set forth in the following document (denoted JCT3V-E0211): Li et al., “AHG7 Related: Differential coding method for DLT in 3D-HEVC,” Document: JCT3V-E0211, Joint Collaborative Team on 3D Video Coding Extension Development of ITU-T SG 16 WP 3 and ISO/IEC JTC 1/SC 29/WG 11, 5^{th} Meeting: Vienna, AT, 27 Jul.-2 Aug. 2013, (hereinafter “JCT3V-E0211”) is available from the following link: http://phenix.it-sudparis.eu/jct2/doc_end_user/current_document.php?id=1225. In JCT3V-E0211, a union set of all DLT are firstly created for all views. For each view, the items in the union set but not present in the DLT for that view are explicitly identified.

Based on the above methods, e.g., of JCT3V-E0130, JCT3V-E0176 and JCT3V-E0211, a straightforward single-view solution, e.g., single-view DLT signaling approach, has been discussed in JCT-3V. It is described as follows with respect to syntax and semantics.

### Syntax

| ... | Descriptor |
|---|---|
| num_depth_values_in_dlt[ i ] | u(v) |
| max_diff[ i ] | u(v) |
| min_diff_minus1[ i ] | u(v) |
| dlt_depth_value0[ i ] | |
| if ( max_diff[ i ] > (min_diff_minus1[ i ]+1) ) | |
| for ( j = 1; j < num_depth_values_in_dlt[ i]; j++) | |
| dlt_depth_value_diff_minus_min[ i ][ j ] | u(v) |
| ... | |

### Semantics

max_diff[i] plus 1 indicates the largest delta depth value between two consecutive depth values for the i-th depth view. max_diff[i] is in the range of 1 to 255, inclusive. [Ed. (CY): the range could be changed according to the higher dynamic range.]
min_diff_minus1[i] indicates the smallest delta depth value between two consecutive depth values for the i-th depth view min_diff_minus1[i] is in the range of 0 to max_diff[i]−1, inclusive. The length of the min_diff_minus1[i] syntax element is Ceil(Log 2(max_diff[i]+1)) bits. MinDiff[i] is set to be min_diff_minus1[i]+1.
dlt_depth_value0[i] specifies the first entry in the DLT for the i-th depth view. dlt_depth_value0[i] is in the range of 0 to 255 inclusive.
dlt_depth_value_diff_minus_min[i][j] plus minDiff[i] specifies the difference of the j-th entry and the (j−1)-th entry in the DLT for current view. dlt_depth_value_diff_minus_min[i][j] is in the range of 0 to (max_diff[i]-MinDiff[i]), inclusive. The length of syntax element dlt_depth_value_diff_minus_min[i][j] Ceil(Log 2 (max_diff[i]-MinDiff[i]+1)) bits. When not present, dlt_depth_value_diff_minus_min[i][j] is derived to be equal to 0.

The array dltDepthValue[i] is derived as follows.

dltDepthValue[i][0]=dlt_depth_value0[i]

for (j=1; j<num_depth_values_in_dlt[i]; j++)
dltDepthValue[i][j]=dltDepthValue[i][j−1]+
dlt_depth_value_diff_minus_min[i][j]+MinDiff[i]

There are potential problems with existing proposals for inter-view prediction of DLT tables. For example, rather than a single continuous series of depth values that overlap between DLT tables of different views, there may be multiple, different continuous regions of depth value overlap between the DLT tables. The existing proposals do not provide an efficient way to cover this case with a simple syntax design.

The techniques described in this disclosure relate to DLT signaling in 3D-HEVC. The techniques can be extended to generic purposes when multiple tables are predicted from each other. The techniques may provide an efficient process for signaling DLTs or other lookup tables, and also when there are multiple, different continuous regions of depth value overlap between the DLT or other types of lookup tables.

Techniques for predicting a current DLT from a reference DLT according to the techniques of this disclosure are as follows. In the following examples, suppose one depth value with the j-th entry in the depth lookup table for depth view components with layer_id equal to i is denoted by dlt_D[i][j]. The following examples may be combined or modified in any manner.

In a first example, when one DLT table is predicted from the other, video encoder 20 signals the additional items, e.g., depth values, that are present in the current lookup table, e.g., DLT, but not in the reference lookup table, e.g., DLT, in an additional entry table. In one sub-example or alternative to the first example, video encoder 20 may signal the additional items in a way similar to how DLTs are signaled.

In a second example, when the reference lookup table, e.g., DLT, contains items, e.g., depth values, that are not present in the current lookup table, e.g., DLT, video encoder 20 signals the indices for the items (j values) in an index table. In one alternative or sub-example of the second example, video encoder 20 explicitly signals (in contrast to implicit signaling of) the indices of the items that are not present, e.g., the index table. In another alternative or sub-example of the second example, video encoder 20 explicitly signals the indices of the items that are not present with differential coding. In another alternative or sub-example of the second example, video encoder 20 signals indices of the items that are present in the reference table but not present in the current table in a way similar to DLT coding.

In a third example, the techniques of the first and second examples may be considered, e.g., implemented, together. For example, video encoder 20 may signal an additional entry table that includes the additional items, e.g., depth values, that are present in the current lookup table, e.g., DLT, but not in the reference lookup table, e.g., DLT. Additionally, video encoder 20 may signal an index table that includes items, e.g., depth values, that are not present in the current lookup table, but are present in the reference table.

Then, the entries in the reference DLT table with index not signaled in the index table are used, e.g., by video decoder 30, to create a temporary table. Afterwards, video decoder 30 may merge the items in the additional entry table and the temporary table into the final table, in a way that a smaller entry of the co-current entry of these two tables is first chosen and then added into the final table and the current position of the table containing the chosen entry is increased by one.

In a fourth example, as in examples one, two or three above, consider the additional entry table and the index table are with two different types. For each depth view, if it is predicted from a reference DLT table, video encoder 20 may signal multiple tables for each type: meaning multiple additional entry tables and/or multiple index tables. For, when one set of entries are continuously and/or closely distributed in one region, e.g. (1 to 50) and one set of entries are continuously and/or closely distributed in another region, e.g., (100 to 200), which has a far distance to the first region, video encoder 20 may signal two tables of the same type, where each entry can be signaled with a smaller number of bits.

In a fifth example, a so-called “generic” design of table signaling is proposed. Video encoder 20 may apply this design for signaling a single-view DLT and additional entries of the DLT and the index entries to be removed from the DLT.

In a sixth example, the reference DLT can always be the DLT of the base view, or the first available depth view that utilizes a DLT. In other words, it may be implicit that the DLT of the base view or first depth view that utilizes the DLT is the reference DLT such that video decoder 30 is configured to associate the base view DLT (or any available lower (or first) depth view that utilizes the DLT) as the reference DLT. Alternatively, video encoder 20 may explicitly (as opposed to the implicit configuration of video decoder 30 to associate a particular DLT as the reference DLT) signal which DLT is the reference DLT, e.g., by the layer_id, by view order index, by the delta of the layer_id, or by the delta of view order index.

Implementation details for DLT signaling for one/multiple views in accordance with the techniques of this disclosure are now described with respect to the following syntax and semantics (where italics denote additions and deletions are marked as removed in square brackets). While described with respect to a video parameter set (VPS), the techniques may also be performed with respect to other sets or headers, including a sequence parameter set, a picture parameter set or a slice header.

### Example #1

### Video Parameter Set Extension Syntax

| vps_extension( ) { | Descriptor |
|---|---|
| ... | |
| ... | |
| if( dlt_flag[ layerId ] ) { | |
| if ( ViewOrderIndex[ layerId ] != 0 ) | |
| inter_view_dlt_pred_enable_flag[ layerId ] | u(1) |
| if ( !inter_view_dlt_pred_enable_flag[ layerId ]){ | |
| num_depth_values_in_dlt[ layerId ] | u(v) |
| max_diff[ layerId ] | u(v) |
| min_diff_minus1[ layerId ] | u(v) |
| dlt_depth_value0[ layerId ] | u(v) |
| if ( max_diff[ layerId ] > (min_diff_minus1[ layerId ]+1) ) | |
| for ( j = 1; j < num_depth_values_in_dlt[ layerId ]; j++) | |
| dlt_depth_value_diff_minus_min[ layerId ][ j ] | u(v) |
| } | |
| else { | |
| // additional entries | |
| add_num_depth_values_in_dlt[ layerId ] | u(v) |
| add_max_diff[ layerId ] | u(v) |
| add_min_diff_minus1[ layerId ] | u(v) |
| add_dlt_depth_value0[ layerId ] | u(v) |
| if ( add_max_diff[ layerId ] > (add_min_diff_minus1[ layerId ]+1) ) | |
| for (j = 1; j < add_num_depth_values_in_dlt[ layerId ]; j++) | |
| add_dlt_depth_value_diff_minus_min[ layerId ][ j ] | |
| // to be removed entries | |
| num_index_values_in_dlt[ layerId ] | u(v) |
| index_max_diff[ layerId ] | u(v) |
| index_min_diff_minus1[ layerId ] | u(v) |
| index_dlt_index_value0[ layerId ] | u(v) |
| if ( index_max_diff[ layerId ] > (index_min_diff_minus1[ layerId ]+1) ) | |
| for (j = 1; j < num_index_values_in_dlt[ layerId ]; j++) | |
| dlt_index_value_diff_minus_min[ layerId ][ j ] | u(v) |
| } | |
| } | |
| ... | |

### Video Parameter Set Extension Semantics

inter_view_dlt_pred_enable_flag[layerId] equal to 1 indicates the depth view with nuh_layer_id equal to layer_id uses the inter-view DLT prediction method to signal the DLT in current view. inter_view_DLT_pred_enable_flag[layerId] equal to 0 indicates the depth view with nuh_layer_id equal to layer_id has the DLT explicitly signalled. When not present, inter_view_dlt_pred_enable_flag[layerId] is inferred to be equal to 0.
max_diff[layerId] plus 1 indicates the largest delta depth value between two consecutive depth values for the i-th depth view. max_diff[layerId] is in the range of 1 to 255, inclusive. [Ed. (CY): the range could be changed according to the higher dynamic range.]
min_diff_minus1[layerId] indicates the smallest delta depth value between two consecutive depth values for the i-th depth view min_diff_minus1[layerId] is in the range of 0 to max_diff[layerId]−1, inclusive. The length of the min_diff_minus1[layerId] syntax element is Ceil(Log 2(max_diff[layerId]+1)) bits. MinDiff[layerId] is set to be min_diff_minus1[layerId]+1.
dlt_depth_value0[layerId] specifies the first entry in the DLT for the i-th depth view. dlt_depth_value0[layerId] is in the range of 0 to 255 inclusive.
dlt_depth_value_diff_minus_min[layerId][j] plus minDiff[layerId] specifies the difference of the j-th entry and the (j−1)-th entry in the DLT for current view. dlt_depth_value_diff_minus_min[layerId][j] is in the range of 0 to (max_diff[layerId]-MinDiff[layerId]), inclusive. The length of syntax element dlt_depth_value_diff_minus_min[layerId][j] Ceil(Log 2(max_diff[layerId]-MinDiff[layerId]+1)) bits. When not present, dlt_depth_value_diff_minus_min[layerId][j] is derived to be equal to 0. When inter_view_dlt_pred_enable_flag[layerId] is equal to 0, the array dltDepthValue[layerId] is derived as follows.
dltDepthValue[layerId][0]=dlt_depth_value0[layerId]

for (j=1; j<num_depth_values_in_dlt[layerId]; j++)
dltDepthValue[layerId][j]=dltDepthValue[layerId][j−1]+

dlt_depth_value_diff_minus_min[i][j]+MinDiff[layerId]

add_max_diff[layerId] plus 1 indicates the largest delta depth value between two consecutive depth values explicitly present for the depth view with nuh_layer_id equal to layerId. max_diff[layerId] is in the range of 1 to 255, inclusive. [In some examples, the range may change according to the higher dynamic range.]
add_min_diff_minus1[layerId] indicates the smallest delta depth value between two consecutive depth values explicitly present for the depth view with nuh_layer_id equal to layerId. add_min_diff_minus1[layerId] is in the range of 0 to add max_diff[layerId]−1, inclusive. The length of the add_min_diff_minus1[layerId] syntax element is Ceil(Log 2(max_diff[layerId]+1)) bits. AddMinDiff[layerId] is set to be add_min_diff_minus1[layerId]+1.
add_dlt_depth_value0[layerId] specifies the first entry explicitly present in the DLT for the depth view with nuh_layer_id equal to layerId. add_dlt_depth_value0[layerId] is in the range of 0 to 255 inclusive.
add_dlt_depth_value_diff_minus_min[layerId][j] plus addMinDiff[layerId] specifies the difference of the j-th entry and the (j−1)-th entry in the DLT for current view. dlt_depth_value_diff_minus_min[layerId][j] is in the range of 0 to (max_diff[layerId]-MinDiff[layerId]), inclusive. The length of syntax element dlt_depth_value_diff_minus_min[layerId][j] Ceil(Log 2(add_max_diff[layerId]-addMinDiff[layerId]+1)) bits. When not present, dlt_depth_value_diff_minus_min[layerId][j] is derived to be equal to 0. The array addDltDepth Value[layerId] is derived as follows.
addDltDepthValue[layerId][0]=add_dlt_depth_value0[layerId]

for (j=1; j<add_num_depth_values_in_dlt[layerId]; j++)
AddDltDepthValue[layerId][j]=addDltDepthValue[layerId][j−1]+

add_dlt_depth_value_diff_minus_min[layerId][j]+AddMinDiff[layerId]

num_index_values_in_dlt[layerId] specifies the number of entries in the reference DLT but are not in the DLT for the depth view with nuh_layer_id equal to layerId.
index_max_diff[layerId] specifies the max differences of the two consecutive indices. Its value is in the range of 0 to 255 inclusive.
index_min_diff_minus1[layerId] specifies the smallest delta index values between two consecutive index values IndexMinDiff[layerId] is set to index_min_diff_minus1[layerId]+1.
index_dlt_index_value0[layerId] specifies the first index value.
dlt_index_value_diff_minus_min[layerId][j] plus IndexMinDiff[layerId] specifies the difference of the j-th index value and the (j−1)-th index value.
The array index Value[layerId] is derived as follows.
indexValue[layerId][0]=index_dlt_depth_value0[layerId]

for (j=1; j<num_index_values_in_dlt[layerId]; j++)
indexValue[layerId][j]=indexValue[layerId][j−1]+

dlt_index_value_diff_minus_min[layerId][j]+IndexMinDiff[layerId]

When inter_view_dlt_pred_enable_flag[layerId] is equal to 1, dltDepthValue[layerId] is derived as follows.
baseLayerId is set equal to the nuh_layer_id of the depth view of the base view.
for (j=0, k=0, 1=0; j<num_depth_values_in_dlt[baseLayerId]; j++)

if (k<num_index_values_in_dlt[layerId] && index Value[layerId][k]==j) k++

else dltDepthValueSubset[l++]=dltDepthValue[baseLayerId][j] numberValues=1

for (j=0; l=0, k=0; l<numberValues∥k<add_num_depth_values_in_dlt[layerId]; j++)

if (k>=add_num_depth_values_in_dlt[layerId]∥(dltDepthValueSubset[l]<AddDltDepthValue[layerId][k]))
dltDepthValue[layerId][j]=dltDepthValueSubset[l++]

else
dltDepthValue[layerId][j]=AddDltDepthValue[layerId][k++]

### Example #2

### Video Parameter Set Extension Syntax

| vps_extension( ) { | Descriptor |
|---|---|
| ... | |
| ... | |
| if( dlt_flag[ layerId ] ) { | |
| if ( ViewOrderIndex[ layerId ] = = 0 ) | |
| inter_view_dlt_pred_enable_flag[ layerId ] | u(1) |
| if ( !inter_view_dlt_pred_enable_flag[ layerId ]) | |
| inc_table( layerId, 8, 0 ) | |
| else { | |
| dlt_ref_layer_id | u(6) |
| inc_table( layerId, 8, 0 ) | |
| inc_table( layerId, 8, 1) | |
| } | |
| } | |
| ... | |

Incremental Table Syntax

| inc_table( index, bitRange, type ) { | Descriptor |
|---|---|
| num_entry | u(v) |
| max_diff | u(v) |
| min_diff_minus1 | u(v) |
| entry0 | |
| if ( max_diff > (min_diff_minus1+1) ) | |
| for ( i = 1; i < num_entry; i++) | |
| entry_value_diff_minus_min[ i ] | u(v) |
| } | |

Incremental Table Semantics

This table consists increasing entries of integer numbers, the i-th entry is always larger than the (i−1)-th entry.
num_entry specifies the number of entris in the incremental table, num_entry is in the range of 0 to (2<<bitRange)−1, inclusive and the length of num_entry is bitRange bits.
max_diff specifies the maximum difference between two consecutive entries of the table. max_diff is in the range of 0 to (2<<bitRange)−1, inclusive and the length of max_diff is bitRange bits.
min_diff_minus1 specifies the minimum difference between two consecutive entries of the table, min_diff_minus1 is in the range of 0 to max_diff−1, inclusive. The length of the min_diff_minus1 is Ceil(Log 2(max_diff+1)) bits minDiff is set to be min_diff_minus1+1.
entry0 specifies the 0-th entry of the table.
entry_value_diff_minus_min[i] plus minDiff specifies the difference between the i-th entry and the (i−1)-th entry.
entry[0]=entry0

for (i=1; i<num_entry; j++)
entry[i]=entry[i−1]+entry_value_diff_minus_min[i]+minDiff
   incTableEntry[i]=entry[i]
   dlt_ref_layer_id specifies the nuh_layer_id of the depth view for which the depth view with nuh_layer_id equal to layerId is predicted from. dlt_ref_layer_id shall be smaller than layerId.
   Alternatively, dlt_ref_layer_id is not signaled and always derived to be the nuh_layer_id of the depth layer of the base view.
   Alternatively, dlt_ref_layer_id is in the range of 0 to layerId−1, inclusive thus has a length of Ceil(Log 2(layerId)) bits.
   Denote the DLT table of the depth view with nuh_layer_id equal to layerId as depthDLT[layerId].
   If inter_view_dlt_pred_enable_flag[layerId] is equal to 0, depthDLT[layerId] is derived as follows.
   numDepthEntry[layerId] is set to be the number of num_entry of the incremental table with index equal to layerId and type equal to 0.
   depthDLT[layerId][i] is set to incTableEntry[i] of the same incremental table, for each i from 0 through numDepthEntry[layerId] of the same incremental table, inclusive.
   Otherwise (inter_view_dlt_pred_enable_flag[layerId] is equal to 1), depthDLT[layerId] is derived as follows.
   Set numAddEntry to be num_entry of the incremental table with index equal to layerId and type equal to 0, and depthAddDLT[i] is set to be incTableEntry[i] of the same incremental table, for each i from 0 through numAddEntry.
   Set numRemoveIndex to be num_entry of the incremental table with index equal to layerId and type equal to 1, and indexRemove[i] is set to be incTableEntry[i] of the same incremental table, for each i from 0 through numRemoveIndex.

for (i=0, j=0, k=0, j<numDepthEntry[del_ref_layer_id].; j++)
if (k<numRemoveIndex && indexRemove[k]==j) k++
else dltDepthValueSubset[i++]=depthDLT[del_ref_layer_id][j] numberSubset=i

for (i=0, j=0, k=0; j<numberSubset∥k<numAddEntry; i++)
if (k>=numAddEntry∥(dltDepthValueSubset[j]<depthAddDLT[k]))
   depthDLT[layerId][i]=dltDepthValueSubset[j++]
else
   depthDLT[layerId][i]=depthAddDLT[k++]
      For any layerId with inter_view_dlt_pred_enable_flag[layerId] equal to 1 and dlt_ref_layer_id equal to refLayerId, the array incTableEntry of the incremental table with index equal to layerId and type equal to 0 and the array incTableEntry of the incremental table with index equal to refLayerId and type equal to 0 do not have a common entry.
      num_entry of the incremental table with index equal to layerId and type equal to 1 shall be in the range of 0 to num_entry of the incremental table with index equal to refLayerId and type equal to 0.
      Alternatively, bitRange of the inc_table with property equal to 1 is set equal to Ceil(num_entry of the incremental table with index equal to layerIdRef and type equal to 0).

Similar to the foregoing examples, instead of using the increasing table to signal the entries to be removed from the reference layer, various aspects of the techniques described in this disclosure may enable the following:

| vps_extension( ) { | Descriptor |
|---|---|
| ... | |
| ... | |
| if( dlt_flag[ layerId ] ) { | |
| if ( ViewOrderIndex[ layerId ] != 0 ) | |
| inter_view_dlt_pred_enable_flag[ layerId ] | u(1) |
| if ( !inter_view_dlt_pred_enable_flag[ layerId ]) | |
| inc_table( layerId, 8, 0 ) | |
| else { | |
| dlt_ref_layer_id | u(6) |
| inc_table( layerId, 8, 0 ) | |
| index_remove_first | u(v) |
| index_remove_last | u(v) |
| for ( i = index_remove_first; i <= | |
| index_remove_last; i++) | |
| index_remove_flag[ i ] | u(1) |
| } | |
| } | |
| ... | |

index_remove_first and index_remove_last indicate the indices to the first and last entry of the DLT table depthDLT[dlt_ref_layer_id] that are to be removed in the DLT table of the current layer. They are both in the range of 0 to numDepthEntry[dlt_ref_layer_id]−1, inclusive.
index_remove_flag[i] specifies whether the i-th entry in depthDLT[dlt_ref_layer_id] is not present in depthDTL[layerId]. When not present, index_remove_flag[i] is inferred to be equal to 0.
Alternatively or in conjunction with various aspects of the techniques described in this disclosure, index_remove_first is not signaled and inferred to be equal to 0.
Alternatively or in conjunction with various aspects of the techniques described in this disclosure, index_remove_last is not signaled and inferred to be equal to numDepthEntry[dlt_ref_layer_id]−1.
The depthDLT table for the current layer with nuh_layer_id equal to layerId is derived as follows:
for (i=0, j=0; j<numDepthEntry[del_ref_layer_id].; j++)

if (!index_remove_flag[i])
dltDepthValueSubset[i++]=depthDLT[del_ref_layer_id][j] numberSubset=i
   for (i=0, j=0, k=0; j<numberSubset∥k<numAddEntry; i++)

if (k>=numAddEntry∥(j<numberSubset && dltDepthValueSubset[j]<depthAddDLT[k]))
depthDLT[layerId][i]=dltDepthValueSubset[j++]

else
depthDLT[layerId][i]=depthAddDLT[k++]

FIG. 7 is a block diagram illustrating an example video encoder 20 that may be configured to implement the techniques of this disclosure. FIG. 7 is provided for purposes of explanation and should not be considered limiting of the techniques as broadly exemplified and described in this disclosure. For purposes of explanation, this disclosure describes video encoder 20 in the context of HEVC coding and, more particularly, 3D-HEVC. However, the techniques of this disclosure may be applicable to other coding standards or methods.

In the example of FIG. 7, video encoder 20 includes a prediction processing unit 100, a residual generation unit 102, a transform processing unit 104, a quantization unit 106, an inverse quantization unit 108, an inverse transform processing unit 110, a reconstruction unit 112, a filter unit 114, a decoded picture buffer 116, and an entropy encoding unit 118. Prediction processing unit 100 includes an inter-prediction processing unit 120 and an intra-prediction processing unit 126. Inter-prediction processing unit 120 includes a motion estimation unit 122 and a motion compensation unit 124. In other examples, video encoder 20 may include more, fewer, or different functional components.

Video encoder 20 may receive video data. Video encoder 20 may encode each CTU in a slice of a picture of the video data. Each of the CTUs may be associated with equally-sized luma coding tree blocks (CTBs) and corresponding CTBs of the picture. As part of encoding a CTU, prediction processing unit 100 may perform quad-tree partitioning to divide the CTBs of the CTU into progressively-smaller blocks. The smaller block may be coding blocks of CUs. For example, prediction processing unit 100 may partition a CTB associated with a CTU into four equally-sized sub-blocks, partition one or more of the sub-blocks into four equally-sized sub-sub-blocks, and so on.

Video encoder 20 may encode CUs of a CTU to generate encoded representations of the CUs (i.e., coded CUs). As part of encoding a CU, prediction processing unit 100 may partition the coding blocks associated with the CU among one or more PUs of the CU. Thus, each PU may be associated with a luma prediction block and corresponding chroma prediction blocks.

Video encoder 20 and video decoder 30 may support PUs having various sizes. As indicated above, the size of a CU may refer to the size of the luma coding block of the CU and the size of a PU may refer to the size of a luma prediction block of the PU. Assuming that the size of a particular CU is 2N×2N, video encoder 20 and video decoder 30 may support PU sizes of 2N×2N or N×N for intra prediction, and symmetric PU sizes of 2N×2N, 2N×N, N×2N, N×N, or similar for inter prediction. Video encoder 20 and video decoder 30 may also support asymmetric partitioning for PU sizes of 2N×nU, 2N×nD, nL×2N, and nR×2N for inter prediction. In accordance with aspects of this disclosure, video encoder 20 and video decoder 30 also support non-rectangular partitions of a PU for depth inter coding.

Inter-prediction processing unit 120 may generate predictive data for a PU by performing inter prediction on each PU of a CU. The predictive data for the PU may include a predictive sample blocks of the PU and motion information for the PU. Inter-prediction unit 121 may perform different operations for a PU of a CU depending on whether the PU is in an I slice, a P slice, or a B slice. In an I slice, all PUs are intra predicted. Hence, if the PU is in an I slice, inter-prediction unit 121 does not perform inter prediction on the PU. Thus, for blocks encoded in I-mode, the predicted block is formed using spatial prediction from previously-encoded neighboring blocks within the same frame.

If a PU is in a P slice, motion estimation unit 122 may search the reference pictures in a list of reference pictures (e.g., “RefPicList0”) for a reference region for the PU. The reference region for the PU may be a region, within a reference picture, that contains sample blocks that most closely corresponds to the sample blocks of the PU. Motion estimation unit 122 may generate a reference index that indicates a position in RefPicList0 of the reference picture containing the reference region for the PU. In addition, motion estimation unit 122 may generate an MV that indicates a spatial displacement between a coding block of the PU and a reference location associated with the reference region. For instance, the MV may be a two-dimensional vector that provides an offset from the coordinates in the current decoded picture to coordinates in a reference picture. Motion estimation unit 122 may output the reference index and the MV as the motion information of the PU. Motion compensation unit 124 may generate the predictive sample blocks of the PU based on actual or interpolated samples at the reference location indicated by the motion vector of the PU.

If a PU is in a B slice, motion estimation unit 122 may perform uni-prediction or bi-prediction for the PU. To perform uni-prediction for the PU, motion estimation unit 122 may search the reference pictures of RefPicList0 or a second reference picture list (“RefPicList1”) for a reference region for the PU. Motion estimation unit 122 may output, as the motion information of the PU, a reference index that indicates a position in RefPicList0 or RefPicList1 of the reference picture that contains the reference region, an MV that indicates a spatial displacement between a sample block of the PU and a reference location associated with the reference region, and one or more prediction direction indicators that indicate whether the reference picture is in RefPicList0 or RefPicList1. Motion compensation unit 124 may generate the predictive sample blocks of the PU based at least in part on actual or interpolated samples at the reference region indicated by the motion vector of the PU.

To perform bi-directional inter prediction for a PU, motion estimation unit 122 may search the reference pictures in RefPicList0 for a reference region for the PU and may also search the reference pictures in RefPicList1 for another reference region for the PU. Motion estimation unit 122 may generate reference picture indexes that indicate positions in RefPicList0 and RefPicList1 of the reference pictures that contain the reference regions. In addition, motion estimation unit 122 may generate MVs that indicate spatial displacements between the reference location associated with the reference regions and a sample block of the PU. The motion information of the PU may include the reference indexes and the MVs of the PU. Motion compensation unit 124 may generate the predictive sample blocks of the PU based at least in part on actual or interpolated samples at the reference region indicated by the motion vector of the PU.

Intra-prediction processing unit 126 may generate predictive data for a PU by performing intra prediction on the PU. The predictive data for the PU may include predictive sample blocks for the PU and various syntax elements. Intra-prediction processing unit 126 may perform intra prediction on PUs in I slices, P slices, and B slices.

To perform intra prediction on a PU, intra-prediction processing unit 126 may use multiple intra prediction modes to generate multiple sets of predictive data for the PU. To use an intra prediction mode to generate a set of predictive data for the PU, intra-prediction processing unit 126 may extend samples from sample blocks of neighboring PUs across the sample blocks of the PU in a direction associated with the intra prediction mode. The neighboring PUs may be above, above and to the right, above and to the left, or to the left of the PU, assuming a left-to-right, top-to-bottom encoding order for PUs, CUs, and CTUs. Intra-prediction processing unit 126 may use various numbers of intra prediction modes, e.g., 33 directional intra prediction modes. In some examples, the number of intra prediction modes may depend on the size of the region associated with the PU.

Prediction processing unit 100 may select the predictive data for PUs of a CU from among the predictive data generated by inter-prediction processing unit 120 for the PUs or the predictive data generated by intra-prediction processing unit 126 for the PUs. In some examples, prediction processing unit 100 selects the predictive data for the PUs of the CU based on rate/distortion metrics of the sets of predictive data. The predictive sample blocks of the selected predictive data may be referred to herein as the selected predictive sample blocks.

Residual generation unit 102 may generate, based on the luma, Cb and Cr coding block of a CU and the selected predictive luma, Cb and Cr blocks of the PUs of the CU, a luma, Cb and Cr residual blocks of the CU. For instance, residual generation unit 102 may generate the residual blocks of the CU such that each sample in the residual blocks has a value equal to a difference between a sample in a coding block of the CU and a corresponding sample in a corresponding selected predictive sample block of a PU of the CU.

Transform processing unit 104 may perform quad-tree partitioning to partition the residual blocks associated with a CU into transform blocks associated with TUs of the CU. Thus, a TU may be associated with a luma transform block and two chroma transform blocks. The sizes and positions of the luma and chroma transform blocks of TUs of a CU may or may not be based on the sizes and positions of prediction blocks of the PUs of the CU. A quad-tree structure known as a “residual quad-tree” (RQT) may include nodes associated with each of the regions. The TUs of a CU may correspond to leaf nodes of the RQT.

Transform processing unit 104 may generate transform coefficient blocks for each TU of a CU by applying one or more transforms to the transform blocks of the TU. Transform processing unit 104 may apply various transforms to a transform block associated with a TU. For example, transform processing unit 104 may apply a discrete cosine transform (DCT), a directional transform, or a conceptually similar transform to a transform block. In some examples, transform processing unit 104 does not apply transforms to a transform block. In such examples, the transform block may be treated as a transform coefficient block.

Quantization unit 106 may quantize the transform coefficients in a coefficient block. The quantization process may reduce the bit depth associated with some or all of the transform coefficients. For example, an n-bit transform coefficient may be rounded down to an m-bit transform coefficient during quantization, where n is greater than m. Quantization unit 106 may quantize a coefficient block associated with a TU of a CU based on a quantization parameter (QP) value associated with the CU. Video encoder 20 may adjust the degree of quantization applied to the coefficient blocks associated with a CU by adjusting the QP value associated with the CU. Quantization may introduce loss of information, thus quantized transform coefficients may have lower precision than the original ones.

Inverse quantization unit 108 and inverse transform processing unit 110 may apply inverse quantization and inverse transforms to a coefficient block, respectively, to reconstruct a residual block from the coefficient block. Reconstruction unit 112 may add the reconstructed residual block to corresponding samples from one or more predictive sample blocks generated by prediction processing unit 100 to produce a reconstructed transform block associated with a TU. By reconstructing transform blocks for each TU of a CU in this way, video encoder 20 may reconstruct the coding blocks of the CU.

Filter unit 114 may perform one or more deblocking operations to reduce blocking artifacts in the coding blocks associated with a CU. Decoded picture buffer 116 may store the reconstructed coding blocks after filter unit 114 performs the one or more deblocking operations on the reconstructed coding blocks. Inter-prediction unit 120 may use a reference picture that contains the reconstructed coding blocks to perform inter prediction on PUs of other pictures. In addition, intra-prediction processing unit 126 may use reconstructed coding blocks in decoded picture buffer 116 to perform intra prediction on other PUs in the same picture as the CU.

Entropy encoding unit 118 may receive data from other functional components of video encoder 20. For example, entropy encoding unit 118 may receive coefficient blocks from quantization unit 106 and may receive syntax elements from prediction processing unit 100. Entropy encoding unit 118 may perform one or more entropy encoding operations on the data to generate entropy-encoded data. For example, entropy encoding unit 118 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. Video encoder 20 may output a bitstream that includes entropy-encoded data generated by entropy encoding unit 118. For instance, the bitstream may include data that represents a RQT for a CU.

The foregoing discussion has focused primarily on encoding of texture (luminance and chrominance) video data. In some examples, video encoder 20 may encode a depth map as if the depth map were a monochrome (greyscale) image, that is, a picture including only luminance information without chrominance information. However, in other examples, video encoder 20 encodes depth data using a simplified depth coding (SDC) mode. Video encoder 20 may compare rate-distortion characteristics between encoding depth data using conventional coding techniques and using SDC mode, and select the mode that yields the best rate-distortion characteristics.

When video encoder 20 determines to encode depth data using SDC, video encoder 20 may encode the depth data using a depth lookup table (DLT) generated for a depth map including the current depth block being coded. That is, video encoder 20 may include a simplified depth coding (SDC) unit 127 that performs simplified depth coding using a current DLT. SDC unit 127 may form the current DLT based on a reference lookup table. To form this current DLT, SDC unit 127 may analyze the full range of possible depth values for the current picture (and possibly additional pictures preceding and subsequent to the current picture in time) and constructs the current DLT such that the current DLT includes each depth value in ascending order. SDC unit 127 may then determine an index lookup table mapping valid depth values to indices. Rather than code the residual depth value for a given coding unit, SDC unit 127 maps the predicted depth value and the original depth value to their corresponding indices in the list of valid depth values to get the residual index. SDC unit 127 then codes the residual index with a significance flag, a sign flag and magnitude information specifying a magnitude of the residual index. SDC unit 127 may also specify the current DLT along with the significance flag, the sign flag and the magnitude information, providing this information to entropy encoding unit 118.

Video encoder 20 is an example of a video encoder configured to perform any of the techniques for encoding lookup tables, e.g., DLTs, as described herein. For example, video encoder 20 is an example of a video encoder configured to encoding video data based on values of a current lookup table, identify a reference lookup table, and signal at least one difference table to a video decoder, the difference table identifying a set of values that are included in one of the reference lookup table and the current lookup table, but not in both of the reference lookup table and the current lookup table. Video encoder 20 then generates the current lookup table based on the reference lookup table and the difference table, and decodes the video data based on values of the generated current lookup table.

In one example, SDC unit 127 may perform the techniques described in this disclosure. That is, SDC unit 127 may predict the video data, e.g., a depth view of 3D video data, based on values of a current lookup table (e.g., a current depth lookup table (DLT)) to generate predicted video data. SDC unit 127 may form the current DLT in the manner described above. However, rather than signal the current DLT in its entirety, SDC unit 127 may, in accordance with the techniques described in this disclosure, identify a reference lookup table and form a difference table specifying a difference in values from the current lookup table an the reference lookup table. This reference lookup table, in some examples, may comprise a DLT of a base view. In some examples, the DLT of the base view may always represent the reference DLT such that no signaling or other syntax elements are necessary to signal the reference table for the current DLT. In this respect, SDC unit 127 may signal the at least one difference table without signaling that the reference DLT comprises the DLT of the base view of the plurality of views.

In other examples, the reference DLT may be the first view that has been encoded using a DLT (which may be the base view or a higher layer view, e.g., an enhancement layer view). Again, the DLT of this first view may always represent the reference DLT, such that no signaling or other syntax elements are necessary to convey the reference table from which the current DLT is to be derived. In this respect, the reference DLT may comprise at least one of a DLT of a base view of the plurality of views or a DLT of a first available depth view encoded using the DLT.

In some instances, rather than configuring a particular view or implicitly signaling the reference DLT, SDC unit 127 may explicitly signal a syntax element identifying a reference view, where the reference DLT comprises a DLT of the reference view. This syntax element, as noted above, may include at least one of a layer_id, a view order index, a delta of the layer_id, or a delta of the view order index.

In any event, SDC unit 127 may signal at least one difference table to a video decoder, the difference table identifying a set of values that are included in one of the reference lookup table and the current lookup table, but not in both of the reference lookup table and the current lookup table, such that the video decoder can reproduce the current lookup table at least in part based on the reference lookup table and the difference table for use in decoding the encoded video data (e.g., the current depth view). As described above, the difference table may include values that are in the reference table so as to signal which values are to be removed from the reference table. The difference table may also include values not included in the reference table so as to signal which values are to be used to update the reference table. In this respect, a video decoder, such as video decoder 30 (FIGS. 1, 3) may derive the current table through application of an ‘XOR’ operation between the reference table and the difference table, as described above. That is, the ‘XOR’ operation may involve a comparison of the reference table to the difference table, such that when a value is included in the difference table but not in the reference table is added to the current table and a value included in both the difference table and the reference table is excluded from the current table.

In this way, SDC unit 127 may signal at least one additional entry table including a set of values that are included in the current lookup table, but not in the reference lookup table. As noted above, signaling of the additional entry table may comprise signaling the additional entry table in a picture parameter set.

Moreover, as noted above, SDC unit 127 may signal multiple additional entry tables, where each of the additional entry tables is associated with a respective one of a number of regions of the current lookup table. These regions may have closely or nearly consecutively numbered depth values in a particular range that differ from one another greatly. As a result, prediction processing unit 100 may signal an additional entry table for each of these regions, possibly reducing the number of bits in comparison to attempting to signal all of the table entries in a single table (possibly due to the large bit depths required to represent the table entries in both regions).

In some examples, SDC unit 127 may signal this difference table by signaling at least one index table including a set of indexes, each of the indexes associated with a respective one of a set of values that are included in the reference lookup table, but not in the current lookup table. Signaling of indexes may allow for more compact representation of the difference table in certain circumstances, thereby preserving bits.

FIG. 8 is a block diagram illustrating an example video decoder 30 that is configured to implement the techniques of this disclosure. FIG. 8 is provided for purposes of explanation and is not limiting on the techniques as broadly exemplified and described in this disclosure. For purposes of explanation, this disclosure describes video decoder 30 in the context of HEVC coding. However, the techniques of this disclosure may be applicable to other coding standards or methods.

In the example of FIG. 8, video decoder 30 includes an entropy decoding unit 150, a prediction processing unit 152, an inverse quantization unit 154, an inverse transform processing unit 156, a reconstruction unit 158, a filter unit 160, and a decoded picture buffer 162. Prediction processing unit 152 includes a motion compensation unit 164 and an intra-prediction processing unit 166. In other examples, video decoder 30 may include more, fewer, or different functional components.

Video decoder 30 may receive a bitstream. Entropy decoding unit 150 may parse the bitstream to decode syntax elements from the bitstream. Entropy decoding unit 150 may entropy decode entropy-encoded syntax elements in the bitstream. Prediction processing unit 152, inverse quantization unit 154, inverse transform processing unit 156, reconstruction unit 158, and filter unit 160 may generate decoded video data based on the syntax elements extracted from the bitstream.

The bitstream may comprise a series of NAL units. The NAL units of the bitstream may include coded slice NAL units. As part of decoding the bitstream, entropy decoding unit 150 may extract and entropy decode syntax elements from the coded slice NAL units. Each of the coded slices may include a slice header and slice data. The slice header may contain syntax elements pertaining to a slice. The syntax elements in the slice header may include a syntax element that identifies a PPS associated with a picture that contains the slice.

In addition to decoding syntax elements from the bitstream, video decoder 30 may perform a reconstruction operation on a non-partitioned CU. To perform the reconstruction operation on a non-partitioned CU, video decoder 30 may perform a reconstruction operation on each TU of the CU. By performing the reconstruction operation for each TU of the CU, video decoder 30 may reconstruct residual blocks of the CU.

As part of performing a reconstruction operation on a TU of a CU, inverse quantization unit 154 may inverse quantize, i.e., de-quantize, coefficient blocks associated with the TU. Inverse quantization unit 154 may use a QP value associated with the CU of the TU to determine a degree of quantization and, likewise, a degree of inverse quantization for inverse quantization unit 154 to apply. That is, the compression ratio, i.e., the ratio of the number of bits used to represent original sequence and the compressed one, may be controlled by adjusting the value of the QP used when quantizing transform coefficients. The compression ratio may also depend on the method of entropy coding employed.

After inverse quantization unit 154 inverse quantizes a coefficient block, inverse transform processing unit 156 may apply one or more inverse transforms to the coefficient block in order to generate a residual block associated with the TU. For example, inverse transform processing unit 156 may apply an inverse DCT, an inverse integer transform, an inverse Karhunen-Loeve transform (KLT), an inverse rotational transform, an inverse directional transform, or another inverse transform to the coefficient block.

If a PU is encoded using intra prediction, intra-prediction processing unit 166 may perform intra prediction to generate predictive blocks for the PU. Intra-prediction processing unit 166 may use an intra prediction mode to generate the predictive luma, Cb and Cr blocks for the PU based on the prediction blocks of spatially-neighboring PUs. Intra-prediction processing unit 166 may determine the intra prediction mode for the PU based on one or more syntax elements decoded from the bitstream.

Prediction processing unit 152 may construct a first reference picture list (RefPicList0) and a second reference picture list (RefPicList1) based on syntax elements extracted from the bitstream. Furthermore, if a PU is encoded using inter prediction, entropy decoding unit 150 may extract motion information for the PU. Motion compensation unit 164 may determine, based on the motion information of the PU, one or more reference regions for the PU. Motion compensation unit 164 may generate, based on samples blocks at the one or more reference blocks for the PU, predictive luma, Cb and Cr blocks for the PU.

As indicated above, video encoder 20 may signal the motion information of a PU using merge mode or AMVP mode. When video encoder 20 signals the motion information of a current PU using AMVP mode, entropy decoding unit 150 may decode, from the bitstream, a reference index, a MVD for the current PU, and a candidate index. Furthermore, motion compensation unit 164 may generate a merge candidate list for the current PU. The merge candidate list includes one or more MV predictor candidates. Each of the MV predictor candidates specifies a MV of a PU that spatially or temporally neighbors the current PU. Motion compensation unit 164 may determine, based at least in part on the candidate index, a selected MV predictor candidate in the merge candidate list. Motion compensation unit 164 may then determine the MV of the current PU by adding the MVD to the MV specified by the selected MV predictor candidate. In other words, for AMVP, MV is calculated as MV=MVP+MVD, wherein the index of the motion vector predictor (MVP) is signaled and the MVP is one of the MV candidates (spatial or temporal) from the merge list, and the MVD is signaled to the decoder side.

If the current PU is bi-predicted, entropy decoding unit 150 may decode an additional reference index, MVD, and candidate index from the bitstream. Motion compensation unit 164 may repeat the process described above using the additional reference index, MD, and candidate index to derive a second MV for the current PU. In this way, motion compensation unit 164 may derive a MV for RefPicList0 (i.e., a RefPicList0 MV) and a MV for RefPicList1 (i.e., a RefPicList1 MV).

In accordance with one or more techniques of this disclosure, one or more units within video decoder 30 may perform one or more techniques described herein as part of a video decoding process. Additional 3D components may also be included within video decoder 30.

Continuing reference is now made to FIG. 8. Reconstruction unit 158 may use the luma, Cb and Cr transform blocks associated with TUs of a CU and the predictive luma, Cb and Cr blocks of the PUs of the CU, i.e., either intra-prediction data or inter-prediction data, as applicable, to reconstruct the luma, Cb and Cr coding blocks of the CU. For example, reconstruction unit 158 may add samples of the luma, Cb and Cr transform blocks to corresponding samples of the predictive luma, Cb and Cr blocks to reconstruct the luma, Cb and Cr coding blocks of the CU.

Filter unit 160 may perform a deblocking operation to reduce blocking artifacts associated with the luma, Cb and Cr coding blocks of the CU. Video decoder 30 may store the luma, Cb and Cr coding blocks of the CU in decoded picture buffer 162. Decoded picture buffer 162 may provide reference pictures for subsequent motion compensation, intra prediction, and presentation on a display device, such as display device 32 of FIG. 1. For instance, video decoder 30 may perform, based on the luma, Cb and Cr blocks in decoded picture buffer 162, intra prediction or inter prediction operations on PUs of other CUs. In this way, video decoder 30 may extract, from the bitstream, transform coefficient levels of the significant luma coefficient block, inverse quantize the transform coefficient levels, apply a transform to the transform coefficient levels to generate a transform block, generate, based at least in part on the transform block, a coding block, and output the coding block for display.

Video decoder 30 is an example of a video decoder configured to perform any of the techniques for decoding lookup tables, e.g., DLTs, as described herein. For example, video decoder 30 is an example of a video decoder configured to retrieve a reference lookup table, receive at least one difference table identifying a set of values that are included in one of the reference table and a current lookup table, but not in both of the reference lookup table and the current lookup table, generate the current lookup table based on the reference lookup table and the difference table, and decode the video data based on values of the generated current lookup table.

In one example, prediction processing unit 152 may include an simplified depth coding (SDC) unit 167 that performs the techniques described above to reconstruct the current DLT from a reference DLT. As noted above, SDC unit 167 may be configured to always identify the reference DLT as one of the DLTs of a base view. Alternatively, SDC unit 167 may be configured to identify the reference DLT as one of the DLTs of a first view (base or higher view) to use a DLT. In this respect, SDC unit 167 may receive the at least one difference table (from entropy decoding unit 150 after having been parsed and entropy decoded by entropy decoding unit 150) without receiving an indication that the reference DLT is the DLT of the base view of the plurality of views.

In some instances, the reference DLT may be explicitly signaled in the bitstream, and entropy decoding unit 150 may parse a syntax element indicative of the reference DLT. This syntax element may therefore comprise at least one of a layer_id, a view order index, a delta of the layer_id, or a delta of the view order index, as described above.

Also, as described above, this current DLT may be reconstructed using at least one additional entry table including a set of values that are included in the current lookup table, but not in the reference lookup table. That is, SDC unit 167 may receive a difference table having values to be added to the identified reference table and, in some instances, having values to be removed from the identified reference table when forming the current table. SDC unit 167 may apply an XOR operation between the difference table and the reference DLT to form the current DLT, which SDC unit 167 may then use when reconstructing the video data (e.g., a depth picture as described above in more detail). Typically, the additional entry table is received via a picture parameter set associated with the current picture or view.

In some examples, various regions may have different clusters of depth values in a certain narrow range where these ranges may be separated by large gaps (e.g., a first region having values in the range of 1-50 and a second region having values in the range of 150-200). In these examples, SDC unit 167 may receive multiple additional entry tables, each of the additional entry tables associated with a respective one of the regions. To generate the current DLT in these examples, SDC unit 167 may generate the current DLT by adding values from each of the additional entry tables to the respective region of the current lookup table.

In various instances, rather than receive the values themselves in the difference table, SDC unit 167 may receive at least one difference table by receiving at least one index table including a set of indexes, each of the indexes associated with a respective one of a set of values that are included in the reference lookup table, but not in the current lookup table. SDC unit 167 may, in these instances, determine a predictor for a DMM-coded region of a depth block from an average of neighboring values of the DMM-coded region. SDC 167 may next decode a residual block for the depth block, where the residual block represents differences in index values of the DLT relative of the index of the average value.

While the techniques of this disclosure are generally described with respect to 3D-HEVC, the techniques are not limited in this way. The techniques described above may also be applicable to other current standards or future standards not yet developed. For example, the techniques for depth coding may also be applicable to other current or future standards requiring coding of a depth component.

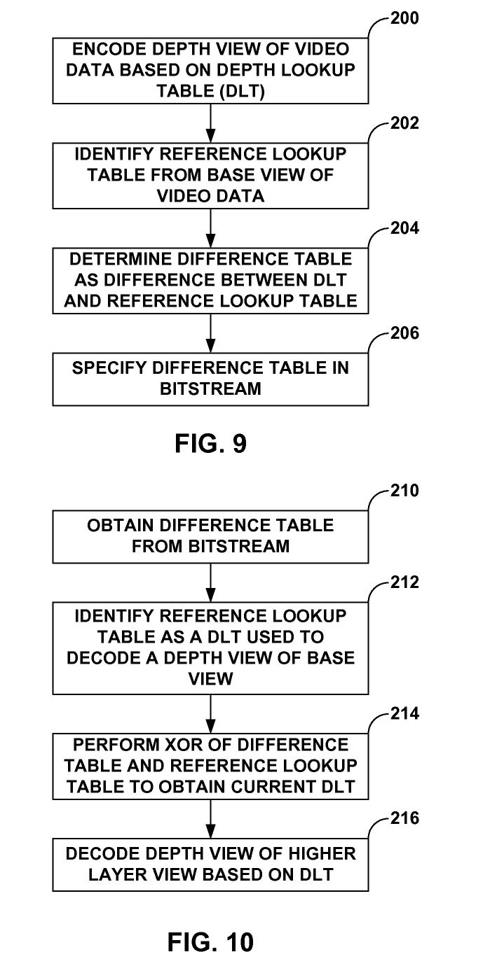

FIG. 9 is a flowchart illustrating configured operation of video encoder 20 in performing the lookup table coding techniques described in this disclosure. As one example, SDC unit 127 of video encoder 20 (shown in FIG. 7) may perform the lookup table coding techniques described in this disclosure. Although described with respect to SDC unit 127, one or more other units of video encoder 20 (including a dedicated lookup table coding unit not shown in the example of FIG. 7) may perform the lookup table coding techniques described in this disclosure.

In any event, SDC unit 127 may first determine or otherwise obtain a depth lookup table and encode a depth view of an enhancement or other higher layer (meaning above a base view in terms of quality, resolution, frame rate, etc.) portion of video data based on the obtained depth lookup table (200). For example, to generate the DLT, SDC unit 127 may determine the set of depth values for a current depth map and sort the depth values in ascending order, such that ascending depth values are associated with increasing index values. After obtaining the depth lookup table, SDC unit 127 may identify a reference lookup table from a base view, as one example, of the video data (202). In some examples, the reference lookup table may not be associated with the base view but a first view (below the current view to be encoded in terms of quality, resolution, frame rate, etc.) having a depth view encoded using a depth lookup table.

In other examples, the reference lookup table may be associated with any view either below or above the current view to be encoded. In these examples where the reference table may be associated with any view, SDC unit 127 may also signal in the bitstream a syntax element identifying the view to which the reference lookup table is associated. In the preceding examples where a pre-defined association of the reference lookup table to a particular view (e.g., either the base view or the first view below the current view to encode a depth view with a depth lookup table), SDC unit 127 may not signal the view to which the reference lookup table is associated given it is implicitly known (meaning a rule is configured in SDC unit 127 to use a depth lookup table associated with a particular view as the reference lookup table).

Regardless of how the reference lookup table is obtained or otherwise determined, SDC unit 127 may determine a difference table as a difference between the current DLT and the reference lookup table (204). There are a number of examples described above as to how this difference table may be determined. SDC unit 127 may determine this difference table such that an XOR operation, when performed on this difference table and the reference lookup table, results in the DLT. Alternatively, SDC unit 127 may identify regions of the current lookup table having values in a particular range and determine a difference table for each region as described above. In some examples, SDC unit 127 may merge the difference tables for each region into a single difference table.

SDC unit 127 may next specify the determined difference table in the bitstream (206), effectively encoding the current DLT as a difference between a reference lookup table and the current DLT. SDC unit 127 may specify this difference table in a picture parameter set associated with the current view to be encoded. The bitstream may include this picture parameter set as a pre-defined syntax table similar to the syntax defined above for the video parameter set (although with additional picture parameter set syntax elements common to picture parameter sets). To specify this difference table in the bitstream, SDC unit 127 may provide the difference table to entropy encoding unit 118, which may entropy encode the difference table using any variety of statistical lossless coding techniques.

FIG. 10 is a flowchart illustrating configured operation of video decoder 30 in performing the lookup table coding techniques described in this disclosure. As one example, SDC unit 167 of video decoder 30 (shown in FIG. 8) may perform the lookup table coding techniques described in this disclosure. Although described with respect to SDC unit 167, one or more other units of video decoder 30 (including a dedicated lookup table coding unit not shown in the example of FIG. 8) may perform the lookup table coding techniques described in this disclosure.

SDC unit 167 may first obtain a difference table for a current encoded view specified in a video data bitstream (210). Entropy decoding unit 150 may parse syntax elements from a picture parameter set (or other parameter set such as a video parameter set or a header, such as a slice header), the syntax elements representative of the difference table. These syntax elements may be similar to those set forth in the above video parameter set syntax table. In any event, entropy decoding unit 150 may entropy decode the syntax elements to obtain the difference table, passing this difference table to SDC unit 167.

SDC unit 167, upon receiving the difference table, may then identify a reference lookup table as a DLT used to decode the depth view of a base view (212). Although described as being configured to always identify the reference lookup table as the DLT used to encode the depth view of the base view, SDC unit 167 may operate in various other ways to identify the reference lookup table. For example, SDC unit 167 may be configured to identify the reference lookup table as the first DLT used to encode a view lower (in terms of quality, resolution, frame rate, etc.) than the current view (which may be the base view or some higher view). In other examples, entropy decoding unit 150 may parse and entropy decode a syntax element identifying the reference lookup table, passing this syntax element to SDC unit 167. SDC unit 167 may then identify the reference lookup table based on the syntax element. In yet other examples, SDC unit 167 may implicitly identify the reference lookup table based on other syntax elements (which do not explicitly identify the reference lookup table as opposed to the explicitly signaled example discussed above).

Regardless of how the reference lookup table is identified, SDC unit 167 may then perform an XOR operation with respect to the difference table and the reference lookup table to obtain the DLT for the current view (214). Although described as performing this XOR operation to obtain the current DLT, SDC unit 167 may obtain the current DLT based on the reference lookup table and the difference table in a number of different ways, as described in more detail above. SDC unit 167 may then decode the depth view of a higher layer view (than the base view) based on the current DLT as described in more detail above (216).

In one or more examples, the functions described herein may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
receiving a reference lookup table;
receiving at least one difference table including a set of values, each value of the set being included or not included in the reference lookup table;
generating a current lookup table based on the reference lookup table and the difference table, wherein the current lookup table includes at least one of a value from the difference table that is not included in the reference table or a value from the reference table that is not included in the difference table; and
decoding the video data based on a set of values of the current lookup table.

2. The method of claim 1, wherein the reference lookup table comprises a reference depth lookup table (DLT), the current lookup table comprises a current DLT, and decoding the video data comprises decoding depth values of the video data based on the generated current DLT.

3. The method of claim 2,
wherein the video data comprises a plurality of views, the current DLT comprises a DLT of a current view of the plurality of views, and the reference DLT comprises a DLT of a base view of the plurality of views, and
wherein receiving the at least one difference table comprises receiving the at least one difference table without receiving an indication that the reference DLT is the DLT of the base view of the plurality of views.

4. The method of claim 2, wherein the video data comprises a plurality of views, the current DLT comprises a DLT of a current view of the plurality of views, and the reference DLT comprises at least one of a DLT of a base view of the plurality of views or a DLT of a first available depth view decoded using the DLT.

5. The method of claim 2, wherein the video data comprises a plurality of views, and the current DLT comprises a DLT of a current view of the plurality of views, the method further comprising receiving a syntax element identifying a reference view, wherein the reference DLT comprises a DLT of the identified reference view.

6. The method of claim 5, wherein receiving the syntax element comprises receiving at least one of a layer_id, a view order index of the reference view, a delta of the layer_id, relative to the layer_id for the current view or a delta of the view order index relative to the view order index for the current view.

7. The method of claim 1, wherein receiving at least one difference table comprises receiving at least one additional entry table including a set of values that are included in the current lookup table, but not in the reference lookup table.

8. The method of claim 7, wherein receiving the additional entry table comprises receiving the additional entry table in a picture parameter set.

9. The method of claim 7, further comprising receiving a plurality of additional entry tables, each of the additional entry tables associated with a respective one of a plurality of regions of the current lookup table, wherein generating the current lookup table comprises adding values from each of the additional entry tables to the respective region of the current lookup table.

10. The method of claim 1, wherein receiving at least one difference table comprises receiving at least one index table including a set of indexes, each of the indexes associated with a respective one of a set of values that are included in the reference lookup table, but not in the current lookup table.

11. A method of encoding video data, the method comprising:
encoding the video data based on values of a current lookup table to generate encoded video data;
identifying a reference lookup table; and
signaling at least one difference table to a video decoder, the difference table identifying a set of values that are included in one of the reference lookup table and the current lookup table, but not in both of the reference lookup table and the current lookup table such that the current lookup table is obtained at least in part based on the reference lookup table and the difference table for use in decoding the encoded video data.

12. The method of claim 11, wherein the reference lookup table comprises a reference depth lookup table (DLT), the current lookup table comprises a current DLT, and encoding the video data comprises encoding depth values of the video data based on the current DLT.

13. The method of claim 12,
wherein the video data comprises a plurality of views, the current DLT comprises a DLT of a current view of the plurality of views, and the reference DLT comprises a DLT of a base view of the plurality of views, and
wherein signaling the at least one difference table comprises signaling the at least one difference table without signaling that the reference DLT comprises the DLT of the base view of the plurality of views.

14. The method of claim 12, wherein the video data comprises a plurality of views, the current DLT comprises a DLT of a current view of the plurality of views, and the reference DLT comprises at least one of a DLT of a base view of the plurality of views or a DLT of a first available depth view encoded using the DLT.

15. The method of claim 12, wherein the video data comprises a plurality of view, and the current DLT comprises a DLT of a current view of the plurality of views, the method further comprising signaling a syntax element identifying a reference view, and wherein the reference DLT comprises a DLT of the reference view.

16. The method of claim 15, wherein signaling the syntax element comprises signaling at least one of a layer_id, a view order index of the reference view, a delta of the layer_id, relative to the layer_id for the current view or a delta of the view order index relative to the view order index for the current view.

17. The method of claim 11, wherein signaling at least one difference table comprises signaling at least one additional entry table including a set of values that are included in the current lookup table, but not in the reference lookup table.

18. The method of claim 17, wherein signaling the additional entry table comprises signaling the additional entry table in a picture parameter set.

19. The method of claim 17, further comprising signaling a plurality of additional entry tables, each of the additional entry tables associated with a respective one of a plurality of regions of the current lookup table.

20. The method of claim 11, wherein signaling at least one difference table comprises signaling at least one index table including a set of indexes, each of the indexes associated with a respective one of a set of values that are included in the reference lookup table, but not in the current lookup table.

21. A device comprising:
one or more processors configured to receive at least one difference table including a set of values, each value of the set being included or not included in the reference lookup table, generate a current lookup table based on the reference lookup table and the difference table, wherein the current lookup table includes at least one of a value from the difference table that is not included in the reference table or a value from the reference table that is not included in the difference table, and decode the video data based on a set of values of the current lookup table; and
a memory configured to store the current lookup table.

22. The device of claim 21, wherein the reference lookup table comprises a reference depth lookup table (DLT), the current lookup table comprises a current DLT, and decoding the video data comprises decoding depth values of the video data based on the generated current DLT.

23. The device of claim 22,
wherein the video data comprises a plurality of views, the current DLT comprises a DLT of a current view of the plurality of views, and the reference DLT comprises a DLT of a base view of the plurality of views, and
wherein the one or more processors are configured to receive the at least one difference table without receiving an indication that the reference DLT is the DLT of the base view of the plurality of views.

24. The device of claim 22, wherein the video data comprises a plurality of views, the current DLT comprises a DLT of a current view of the plurality of views, and the reference DLT comprises at least one of a DLT of a base view of the plurality of views or a DLT of a first available depth view decoded using the DLT.

25. The device of claim 22, wherein the video data comprises a plurality of view, and the current DLT comprises a DLT of a current view of the plurality of views, the method further comprising receiving a syntax element identifying a reference view, wherein the reference DLT comprises a DLT of the identified reference view.

26. A device comprising:
a memory configured to store a current lookup table; and
one or more processors configured to encode the video data based on values of the current lookup table to generate encoded video data, identify a reference lookup table, and signal at least one difference table to a video decoder, the difference table identifying a set of values that are included in one of the reference lookup table and the current lookup table, but not in both of the reference lookup table and the current lookup table such that the current lookup table is obtained at least in part based on the reference lookup table and the difference table for use in decoding the encoded video data.

27. The device of claim 26, wherein the reference lookup table comprises a reference depth lookup table (DLT), the current lookup table comprises a current DLT, and encoding the video data comprises encoding depth values of the video data based on the current DLT.

28. The device of claim 27,
wherein the video data comprises a plurality of views, the current DLT comprises a DLT of a current view of the plurality of views, and the reference DLT comprises a DLT of a base view of the plurality of views, and
wherein the one or more processors are configured to signal the at least one difference table without signaling that the reference DLT comprises the DLT of the base view of the plurality of views.

29. The device of claim 27, wherein the video data comprises a plurality of views, the current DLT comprises a DLT of a current view of the plurality of views, and the reference DLT comprises at least one of a DLT of a base view of the plurality of views or a DLT of a first available depth view encoded using the DLT.

30. The device of claim 27, wherein the video data comprises a plurality of view, and the current DLT comprises a DLT of a current view of the plurality of views, the method further comprising signaling a syntax element identifying a reference view, and wherein the reference DLT comprises a DLT of the reference view.
